(19) United States
(12) Patent Application Publication
(10) Pub. No.: US 2025/0309563 A1
(43) Pub. Date: Oct. 2, 2025

(54) MULTI-FEED ANTENNA STRUCTURES

(71) Applicant: Intel Corporation, Santa Clara, CA (US)

(72) Inventors: Harry SKINNER, Beaverton, OR (US); Ofir DEGANI, Nes-Ammin (IL); Ronen KRONFELD, Shoham (IL); Jayprakash THAKUR, Bangalore (IN); John ROMAN, Hillsboro, OR (US); Nawfal ASRIH, Mandelieu-la-Napoule (FR); Seong-Youp SUH, Portland, OR (US); Tae Young YANG, Portland, OR (US); Serge DAO, Vallauris (FR); Walid EL HAJJ, Antibes (FR); Oren Ezra AVRAHAM, Givat Shmuel (IL); Jay Vishnu GUPTA, Bengaluru (IN); Prathibha PEDDIREDDY, Bangalore (IN)

(21) Appl. No.: 19/062,151

(22) Filed: Feb. 25, 2025

(30) Foreign Application Priority Data
Mar. 27, 2024 (EP) 24 166 791.4

(51) Int. Cl. H01Q 21/28; H01Q 5/378; H01Q 15/00

(52) U.S. Cl. CPC H01Q 21/28; H01Q 5/378; H01Q 15/0086

(57) ABSTRACT

A multi-feed antenna structure may include a first antenna port; a first radiating structure coupled to the first antenna port; a second antenna port; a second radiating structure coupled to the second antenna port; and an electromagnetic structure located between the first radiating structure and the second radiating structure.

### CROSS-REFERENCE TO RELATED APPLICATIONS

This application claims priority to European Patent Application EP 24 166 791.4, filed on Mar. 27, 2024, the entire contents of which are incorporated by reference herein.

### TECHNICAL FIELD

Various aspects of this disclosure relate generally to multi-feed antenna structures.

### BACKGROUND

The number of radio technologies at different frequency ranges are increasing with smaller devices form factor, e.g. laptop, convertible, tablet, smartphone. This adds more constraints in terms of mechanical, digital, and radio frequency (RF) designs. Furthermore, the evolution of wireless technologies e.g. 5G, Wi-Fi 7 and the diversity of user applications e.g. communication, sensing, gaming, localization, etc. requires more and more complex RF architecture ensuring that multiple radio transceivers can operate concurrently to improve the product performance and user experience.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 is a network diagram illustrating an example network environment in accordance with one or more aspects of this disclosure;

FIG. 2 shows a functional diagram of an exemplary communication station that may be suitable for use as a user device, in accordance with one or more aspects of this disclosure;

FIG. 3 shows a block diagram of an example machine upon which any of one or more techniques (e.g., methods) may be performed, in accordance with one or more aspects of this disclosure;

FIGS. 4A and 4B show a multi-feed antenna structure (FIG. 4A) and an exemplary alternative electromagnetic metamaterial structure (FIG. 4B) in accordance with various aspects of this disclosure;

FIGS. 5A to 5C show the principle of operation and the role of every metallic element in the design of a multi-feed antenna structure in accordance with various aspects of this disclosure;

FIG. 6 shows the multi-feed antenna structure of FIG. 4A illustrating various design parameters in accordance with various aspects of this disclosure;

FIGS. 7A to 7C show a qualitative behavior of the isolation phenomena in the design of a multi-feed antenna structure in accordance with various aspects of this disclosure;

FIG. 8 shows a transmission coefficient vs frequency diagram for a multi-feed antenna structure with an electromagnetic metamaterial structure and a multi-feed antenna structure without an electromagnetic metamaterial structure;

FIG. 9 shows the multi-feed antenna structure of FIG. 4A together with two coaxial cables connected to the antenna ports;

FIG. 10 shows antenna reflection coefficients for the multi-feed antenna structure of FIG. 9;

FIG. 11 shows antenna radiation characteristics for the first radiating structure at LB, HB, and UHB in accordance with various aspects of this disclosure;

FIGS. 12A to 12D show various components of a multi-feed antenna structure in accordance with various aspects of this disclosure;

FIGS. 13A to 13B show a top side view (FIG. 13A) and a top view (FIG. 13B) of a slot antenna portion of a multi-feed antenna structure in accordance with various aspects of this disclosure;

FIGS. 14A to 14B show a top side view (FIG. 14A) and a side view (FIG. 14B) of an assembled multi-feed antenna structure in accordance with various aspects of this disclosure;

FIG. 15 shows an assembled multi-feed antenna structure positioned in a metal cavity in accordance with various aspects of this disclosure;

FIG. 16 shows a diagram illustrating the characteristics of the slot antenna and the NFRP antenna in accordance with various aspects of this disclosure;

FIGS. 17A to 17B show calculated antenna radiation patterns of the multi-feed antenna structure of FIG. 15 in accordance with various aspects of this disclosure;

FIG. 18 shows a diagram illustrating envelop correlation coefficient (ECC) in accordance with various aspects of this disclosure;

FIG. 19 shows a multi-feed antenna structure in accordance with various aspects of this disclosure;

FIGS. 20A to 20C show two WLAN antennas placed nearby without any isolation circuit or ground etching as a reference case (FIG. 20A) and a corresponding S-parameter diagram (FIG. 20B) and a corresponding antenna efficiency diagram (FIG. 20C);

FIGS. 21A to 21C show two WLAN antennas placed nearby with an electrically conductive isolation portion, but without a ground etching (FIG. 21A) and a corresponding S-parameter diagram (FIG. 21B) and a corresponding antenna efficiency diagram (FIG. 21C);

FIGS. 22A to 22C show two WLAN antennas placed nearby with shunt components between the antennas, but without a ground etching (FIG. 22A) and a corresponding S-parameter diagram (FIG. 22B) and a corresponding antenna efficiency diagram (FIG. 22C);

FIGS. 23A to 23C show two WLAN antennas placed nearby with only a ground etching between the antennas (FIG. 23A) and a corresponding S-parameter diagram (FIG. 23B) and a corresponding antenna efficiency diagram (FIG. 23C);

FIGS. 24A to 24C show two WLAN antennas placed nearby with an electrically conductive isolation portion and a ground etching between the antennas (FIG. 24A) and a corresponding S-parameter diagram (FIG. 24B) and a corresponding antenna efficiency diagram (FIG. 24C);

FIG. 25 shows the validation setup that includes the multi-feed antenna structure of FIG. 19 in accordance with various aspects of this disclosure;

FIG. 26 shows an S-parameter diagram measured for the validation setup of FIG. 25;

FIGS. 27A to 27B show an antenna efficiency diagram (FIG. 27A) for the first radiating structure and an antenna efficiency diagram (FIG. 27B) for the second radiating structure measured for the validation setup of FIG. 25; and

FIG. 28 shows a multi-feed antenna structure in accordance with various aspects of this disclosure.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

The multiplication of radio front ends has a direct impact on the complexity, cost and integration aspects. To reduce these impacts, distributing the constraints or the “intelligence” on different RF components e.g. antenna, filters, diplexers, etc. is provided in various aspects of this disclosure.

The following examples relate to any radio technology, e.g.
a Wide Area Network technology (such as a technology in accordance with a 3rd Generation Partnership Project, such as 4G, 5G, 6G or CDMA 2000, and the like) or
a Wireless Area Network technology (such as a technology in accordance with an IEEE 802.11 standard, e.g. Wi-Fi 8 (IEEE 802.11bn or ultra high reliability (UHR)) or IEEE 802.11be (Wi-Fi 7) standard), or
a Near Field Radio technology (such as a Bluetooth standard).

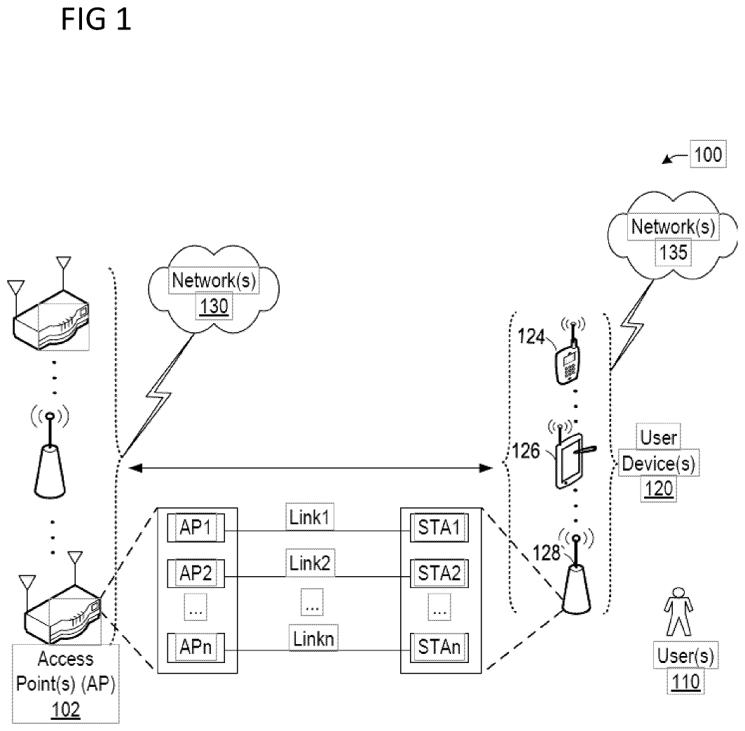

FIG. 1 is a network diagram illustrating an example network environment according to some aspects of this disclosure. Wireless network 100 may include one or more user devices 120 and one or more access points(s) (AP) 102, which may e.g. communicate in accordance with IEEE 802.11 communication standards. The user device(s) 120 may be mobile devices that are non-stationary (e.g., not having fixed locations) or may be stationary devices.

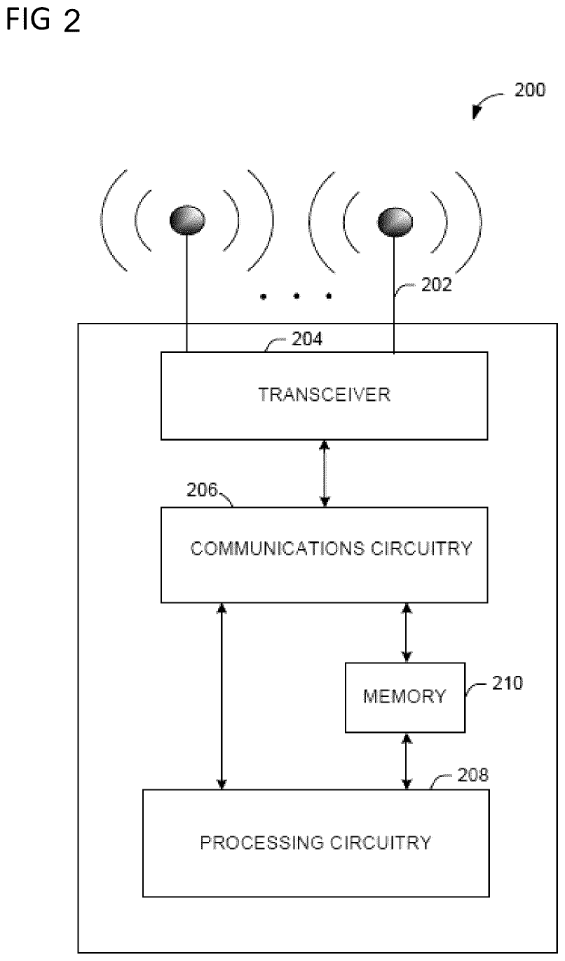

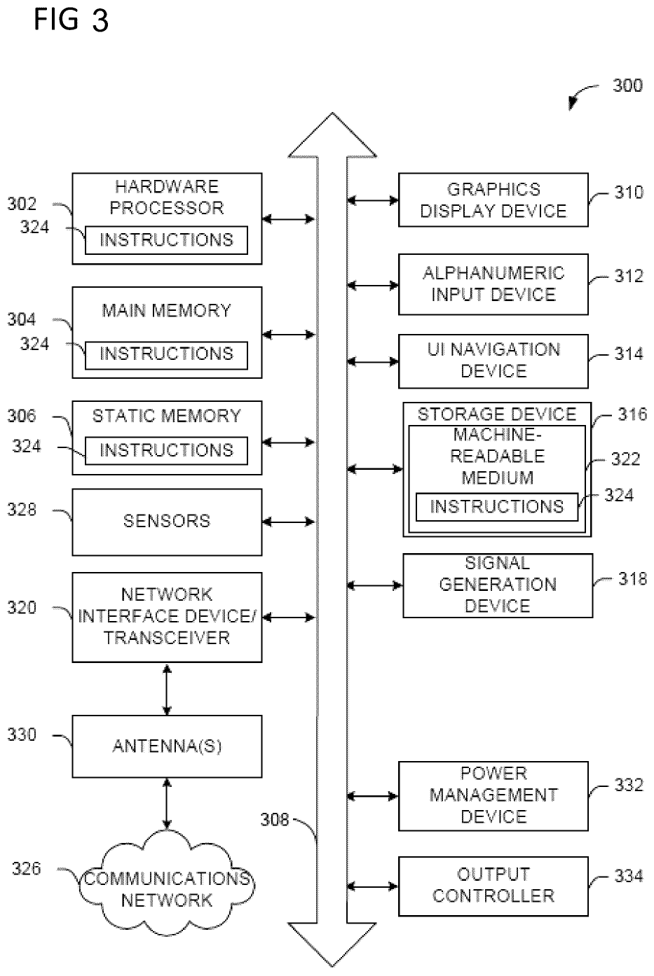

The user devices 120 and the AP 102 may include one or more computer systems similar to that of the functional diagram of FIG. 2 and/or the example machine/system of FIG. 3.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards or in accordance with any other desired radion communication technology. The radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, etc.), 6 GHz channels (e.g., 802.11ax, 802.11be, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). Non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

A user device 120 may be in communication with one or more APs 102. The one or more APs 102 may be multi-link devices (MLDs) and the one or more user device 120 may be non-AP MLDs. Each of the one or more APs 102 may include a plurality of individual APs (e.g., AP1, AP2, . . . , APn, where n is an integer) and each of the one or more user devices 120 may include a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

FIG. 2 shows a functional diagram of an exemplary communication station (in general radio communication terminal device) 200, in accordance with one or more aspects of the present disclosure. FIG. 2 illustrates a functional block diagram of a communication station that may be suitable for use as an Access Point or a user device (e.g. a User Equipment, UE) in accordance with various aspects of this disclosure. The communication station 200 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 200 may include communications circuitry 206 and a transceiver 204 for transmitting and receiving signals to and from other communication stations using one or more antennas 202. The communications circuitry 206 may include circuitry that can operate the physical layer (PHY) communications and/or medium access control (MAC) communications for controlling access to the wireless medium, and/or any other communications layers for transmitting and receiving signals. The communication station 200 may also include processing circuitry 208 and memory 210 arranged to perform the operations described herein. The communications circuitry 206 and the processing circuitry 208 may be configured to perform operations detailed in the below figures, diagrams, and flows.

The communications circuitry 206 may be arranged to contend for a wireless medium and configure frames or packets for communicating over the wireless medium. The communications circuitry 206 may be arranged to transmit and receive signals. The communications circuitry 206 may also include circuitry for modulation/demodulation, upconversion/downconversion, filtering, amplification, etc. The processing circuitry 208 of the communication station 200 may include one or more processors. In other aspects, two or more antennas 202 may be coupled to the communications circuitry 206 arranged for sending and receiving signals. The memory 210 may store information for configuring the processing circuitry 208 to perform operations for configuring and transmitting message frames and performing the various operations described herein. The memory 210 may include any type of memory, including non-transitory memory, for storing information in a form readable by a machine (e.g., a computer). For example, the memory 210 may include a computer-readable storage device, read-only memory (ROM), random-access memory (RAM), magnetic disk storage media, optical storage media, flash-memory devices and other storage devices and media.

The communication station 200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

The communication station 200 may include one or more antennas 202. The antennas 202 may include one or more directional or omnidirectional antennas, including, for example, dipole antennas, monopole antennas, patch antennas, loop antennas, microstrip antennas, or other types of antennas suitable for transmission of RF signals. In some aspects of this disclosure, instead of two or more antennas, a single antenna with multiple apertures may be used. In these aspects, each aperture may be considered a separate antenna. In some multiple-input multiple-output (MIMO) aspects, the antennas 202 may be effectively separated for spatial diversity and the different channel characteristics that may result between each of the antennas and the antennas of a transmitting station.

In some embodiments, the communication station 200 may include one or more of a keyboard, a display, a non-volatile memory port, multiple antennas, a graphics processor, an application processor, speakers, and other mobile device elements. The display may be an LCD screen including a touch screen.

Although the communication station 200 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. The functional elements of the communication station 100 may refer to one or more processes operating on one or more processing elements.

Certain aspects of this disclosure may be implemented in one or a combination of hardware, firmware, and software. Other aspects may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. The communication station 100 may include one or more processors and may be configured with instructions stored on a computer-readable storage device.

FIG. 3 illustrates a block diagram of an example of a machine 300 or system upon which any one or more of the techniques (e.g., methodologies) discussed herein may be performed. The machine 300 may operate as a standalone device or may be connected (e.g., networked) to other machines. In a networked deployment, the machine 300 may operate in the capacity of a server machine, a client machine, or both in server-client network environments. In an example, the machine 300 may act as a peer machine in peer-to-peer (P2P) (or other distributed) network environments. The machine 300 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 300 may include a hardware processor 302 (e.g., a central processing unit (CPU), a graphics processing unit (GPU), a hardware processor core, or any combination thereof), a main memory 304 and a static memory 306, some or all of which may communicate with each other via an interlink (e.g., bus) 308. The machine 300 may further include a power management device 332, a graphics display device 310, an alphanumeric input device 312 (e.g., a keyboard), and a user interface (UI) navigation device 314 (e.g., a mouse). In an example, the graphics display device 310, alphanumeric input device 312, and UI navigation device 314 may be a touch screen display. The machine 300 may additionally include a storage device (i.e., drive unit) 316, a signal generation device 318 (e.g., a speaker), a network interface device/transceiver 320 coupled to antenna(s) 330, and one or more sensors 328, such as a global positioning system (GPS) sensor, a compass, an accelerometer, or other sensor. The machine 300 may include an output controller 334, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 302 for generation and processing of the baseband signals and for controlling operations of the main memory 304, and/or the storage device 316. The baseband processor may be provided on a single radio card, a single chip, or an integrated circuit (IC).

The storage device 316 may include a machine readable medium 322 on which is stored one or more sets of data structures or instructions 324 (e.g., software) embodying or utilized by any one or more of the techniques or functions described herein. The instructions 324 may also reside, completely or at least partially, within the main memory 304, within the static memory 306, or within the hardware processor 302 during execution thereof by the machine 300. In an example, one or any combination of the hardware processor 302, the main memory 304, the static memory 306, or the storage device 316 may constitute machine-readable media.

While the machine-readable medium 222 is illustrated as a single medium, the term “machine-readable medium” may include a single medium or multiple media (e.g., a centralized or distributed database, and/or associated caches and servers) configured to store the one or more instructions 324.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 300 and that cause the machine 300 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 324 may further be transmitted or received over a communications network 326 using a transmission medium via the network interface device/transceiver 320 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 320 may include one or more physical jacks (e.g., Ethernet, coaxial, or phone jacks) or one or more antennas to connect to the communications network 326. In an example, the network interface device/transceiver 320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 300 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The transceiver 320 and the one or more antennas 330 may be coupled with each other via one or more antenna ports (not shown in FIG. 3) and one or more radio frequency cables, e.g. one or coaxial (coax) cables (not shown in FIG. 3). In other words, one antenna port may be associated with and coupled with one or more antennas.

As mentioned above, since the number of different radio technologies which are integrated in one common communication (e.g. terminal) device, the design of the antenna(s) becomes more crucial. Improved antenna architectures and topologies can be useful to reduce the design constraints in RF front end, increase flexibility, mitigate regulatory compliance issues while ensuring good user experience and cost optimization. The concept of multi-feed antennas had been introduced to improve flexibility involving specific constraints on the RF, analog and digital interfaces of communication devices for optimizing the communication interfaces. The RF subsystem design should be as simple as possible so that the multiple antenna feeds can for example act as prefiltering stages with good isolation reducing constraints for diplexers designs. On the other hand, these feeds can operate at the same frequency band enabling Multiple Input Multiple Output (MIMO) solutions and ensuring diversity that improves receiver performance. The concept ensures analog/digital (A/D) and digital/analog (D/A) conversion operations as closely as possible to the antenna to enhance the digital reconfigurability. However, the main challenge of this antenna architecture is to ensure high isolation between ports. The higher the isolation the better the antenna contribution in reducing constraints and cost in an RF chain (e.g. RF transmitter (Tx) chain (also referred to as RF transmitter (Tx) path) or RF receiver (Rx) chain (also referred to as RF receiver (Rx) path)).

An exemplary application of a high-isolation multi-feed antenna is a dual-radio connectivity (Wi-Fi/BT) product e.g. Wi-Fi 7 MLO-Multi-Link Operation, including Simultaneous Transmit Receive (STR), for example in the 5 GHz to 7 GHz frequency band, where throughput and latency can be improved compared with a Single-Radio operation. The high-isolation multi-feed antenna can facilitate these performance improvements at relatively low-cost.

Different methods or techniques have conventionally been used to increase isolation between antenna feeds while covering the required bandwidth. Some techniques use stubs at the antenna port input to filter a specific frequency, other methods use the EM modal analysis to choose the best location of the feed. Some solutions use specific shapes between the radiating elements e.g. T-shapes to block the current propagation between ports.
The conventional isolation solutions are generally narrow band or not broadband enough to cover all the frequency bands of a specific technology such as Wi-Fi 2.4 GHz, 5 GHZ and 6 GHz frequency bands.
The conventional multi-feed antennas with multi-band coverage are generally cumbersome and not adapted to be integrated in platforms or communication devices.
With conventional isolation techniques previously mentioned, the isolation level over a large bandwidth is generally limited to 15 dB to 18 dB. However, the requirements of new radio architectures for advanced wireless applications e.g. dual-radio requires much higher isolation to achieve expected cost vs. performance i.e. 25 dB to 35 dB.
Achieving higher isolation and large or multiple bandwidths induce most often more complexities and higher cost in terms of antenna topology i.e. bigger size, multi-layer, complex feeding. This is not suitable for the applicability of this multi-feed antenna for cost reduction and high-volume deployment with the wireless solution.

Various aspects of this disclosure illustratively provide a multi-feed (e.g. dual-feed) antenna system solution with a new isolation technique using metamaterial periodic structures acting as electromagnetic (EM) band gap to reach an isolation level in the range from about 25 dB to about 30 dB and over a large bandwidth up to e.g. 32% and in a small area lower than 60×5 mm².

Antenna structures in accordance with various aspects of this disclosure may provide the following features:
Enable the implementation of multi-radio wireless solutions with low cost and good performance by ensuring a high isolation level.
Solve different issues related to sensing applications like ambiguity.
Low cost and High volume manufacturable solution with relatively simple manufacturing process.
No additional cost since the antenna structure is a part of initial structure and no additional specific hardware needs to be included.
Improve platforms performance and user experience.
Provide the flexibility to use this antenna structure as a single dual-feed antenna structure or as two separate antennas for MIMO operation.
The antenna structure is extendible to multiple feeds, e.g., three ports or more. This may become relevant to 3×3 MIMO Wi-Fi systems, or 2×2 MIMO+3rd antenna for Bluetooth, and the like.

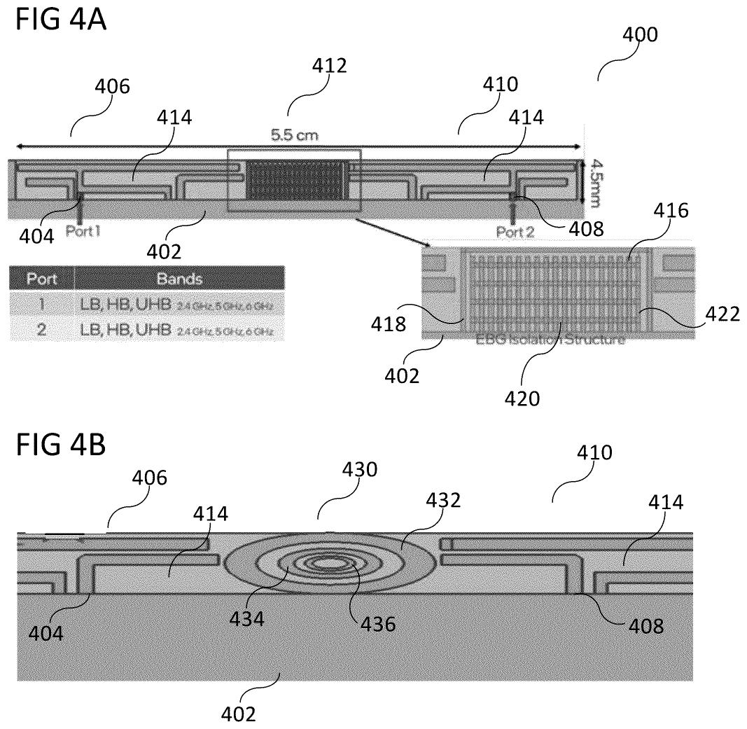

FIG. 4A shows a multi-feed antenna structure 400 in accordance with various aspects of this disclosure.

The multi-feed antenna structure 400 may include a carrier 402, e.g. a printed circuit board (PCB) 402, e.g. a PCB substrate FR4 or any other suitable material.

The multi-feed antenna structure 400 may further include a first antenna port 404 and a first radiating structure (also referred to as first radiating element) 406 coupled to the first antenna port 404. A signal feed to the first radiating structure 406 is implemented via the first antenna port 404. The first antenna port 404 and the first radiating structure 406 are mounted on the carrier 402.

The multi-feed antenna structure 400 may further include a second antenna port 408 and a second radiating structure (also referred to as second radiating element) 410 coupled to the second antenna port 408. A signal feed to the second radiating structure 410 is implemented via the second antenna port 408. The second antenna port 408 and the second radiating structure 410 are also mounted on the carrier 402.

The multi-feed antenna structure 400 may further include an electromagnetic metamaterial structure 412 located between the first radiating structure 406 and the second radiating structure 410. The electromagnetic metamaterial structure 412 may also be mounted on the carrier 402. As an example, the electromagnetic metamaterial structure 412 may be implemented by an electromagnetic band gap.

Although the electromagnetic metamaterial structure 412 serves as an electromagnetic isolation to electromagnetically isolate the first radiating structure 406 and the second radiating structure 410 from each other, the electromagnetic metamaterial structure 412 may be part of the multi-feed antenna in the sense that it is configured as a filter, e.g. a stopband filter, in one or more predefined frequency bands, but also provides a certain transmittivity in predefined frequency bands, which can also be predefined by the structure and the elements of the electromagnetic metamaterial structure 412. In other words, the electromagnetic metamaterial structure 412 forms a part of the impedance of the antenna (e.g. of the first radiating structure 406 and the second radiating structure 410). Illustratively, the electromagnetic metamaterial structure 412 may act as metamaterial electromagnetic (EM) band gap to improve isolation between the two feeds, i.e. between the first port 404 and the second antenna port 408.

The electromagnetic metamaterial structure 412 may be configured to provide at least 20 dB isolation between the first radiating structure 406 and the second radiating structure 410 or between the first antenna port 404 and the second antenna port 408. By way of example, the electromagnetic metamaterial structure 412 may be configured to provide an isolation between the first radiating structure 406 and the second radiating structure 410 and/or between the first antenna port 404 and the second antenna port 408 in the range from about 20 dB to about 60 dB, e.g. in the range from about 30 dB to about 50 dB, e.g. in the range from about 35 dB to about 45 dB.

Various implementations of the electromagnetic metamaterial structure 412 will be presented in more detail below. Illustratively, the electromagnetic metamaterial structure 412 may form an array of capacitors and inductors to act as a filter.

The first radiating structure 406, the second radiating structure 410, and the electromagnetic metamaterial structure 412 may be printed on the carrier 402 and also embedded in electrically insulating material 414. Thus provides a very cost efficient and simple manufacturing process. In various aspects of this disclosure, the insulating material 414 may be the substrate of the PCB (in this case FR4). Thus, in some aspects, the carrier 402 itself may be the insulating material 114. In some aspects, the first radiating structure 406, the second radiating structure 410, and the electromagnetic metamaterial structure 412 may be printed on the carrier 402, e.g. the substrate (e,g, FR4 substrate).

The electromagnetic metamaterial structure 412 may be formed by or include electrically conductive material, such as one or more metals (e.g. Cu, Ag, Au, or the like) or sufficiently doped semicondctor material (e.g. highly doped silicon or other highly doped semiconductor material).

The exemplary implementation of the electromagnetic metamaterial structure 412 in FIG. 4A may have one or more portions of electrically conductive material, e.g. two portions, e.g. an inner portion and a surrounding portion (also referred to as a frame portion) partially surrounding the inner portion and illustratively functioning as a Faraday cage for the inner portion. The electrically conductive material of the inner portion may form a regular, e.g. periodic structure, having a periodicity in one or more directions. Thus, by way of example, the electrically conductive material may form a periodic line structure extending in one direction (the periodic line structure may have any desired shape), a two-dimensional periodic grid structure, or a three-dimensional (cubic) periodic grid structure.

FIG. 4B shows an alternative electromagnetic metamaterial structure 430 having an ellipse shape. By way of examples, the electromagnetic metamaterial structure 430 may have one or more ring shape or ellipse shape structures. For example, the electromagnetic metamaterial structure 430 may include a plurality of ring shape or ellipse shape structures structures, which may be located concentric to each other. In various aspects, the electromagnetic metamaterial structure 430 may include an outer elliptical ring 432, one or more inner elliptical rings being located concentrically with the outer elliptical ring 432. By way of example, the one or more inner elliptical rings may include a first inner elliptical ring 434 located concentrically to and within the outer elliptical ring 432 and a second inner elliptical ring 436 located concentrically to and within the first inner elliptical ring 434.

The periodicity may be in the range of about one fifth of the wavelength (at center frequency of isolation frequency band) of the signals transmitted via the radiating structures 406, 410 or of the signals received via the radiating structures 406, 410.

The example in FIG. 4A shows an implementation of the electromagnetic metamaterial structure 412 having an inner grid structure 416 and a frame portion 418 partially surrounding the inner grid structure 416. The inner grid structure 416 may include a plurality of first electrically conductive lines 420 running parallel to each other in a first direction (e.g. in parallel with a surface of the carrier 402) and a plurality of second electrically conductive lines 422 running parallel to each other in a second direction (e.g. perpendicular to the surface of the carrier 402). The second direction is different from the first direction. By way of example, the second direction may be perpendicular to the first direction. The first electrically conductive lines 420 and the second electrically conductive lines 422 may cross each other and may connect to each other at the crossing points, thereby forming the grid structure. The frame portion 418 may have a substantially rectangular shape or a substantially elliptical shape or any other desired shape. The inner grid structure 416 and the frame portion 418 may be formed on the carrier 402 and may be embedded in electrically insulating material 414.

In a more concrete exemplary implementation, the first antenna port 404, the first radiating structure 406, the second antenna port 408, the second radiating structure 410 and the electromagnetic metamaterial structure 412 are printed on a PCB substrate FR4 402 (one example for the carrier 402) with a permittivity of 4.4 and a thickness of 0.4 mm and connected to a ground plane presenting the chassis of the device (which may be a portion of the carrier 402, e.g. a bottom portion of the carrier 402 shown in FIG. 4A). The antenna is fed at the first antenna port 404 (Port 1) and the second antenna port 408 (Port 2) locations, respectively, as shown in FIG. 4A. The feeding can be done by soldering a coaxial cable (or any other suitable cable) between a ground plane and the antenna, i.e. between a ground plane and the ports 404, 408. Any type of RF connector (instead of the coaxial cable) may also be used.

The dimensions presented in FIG. 4A are suitable e.g. for a design for Wi-Fi frequency range to cover Low Band (LB, 2.4 GHZ), High Band (HB, 5 GHZ) and Ultra-High Band (UHB, 6 GHZ) according to the indicated antenna ports. In this exemplary case, the total Keep Out Zone of the antenna structure 400 is around 60 mm×5 mm which makes it suitable for integration in a common platform.

The multi-feed antenna structure 400 may be configured to simultaneously transmit and/or receive radio signals. The multi-feed antenna structure 400 may be configured as a Dual-Radio Connectivity antenna structure.

As mentioned above, additional antenna ports and associated additional radiating structures may be provided in the multi-feed antenna structure 400, e.g. a third antenna port and a third radiating structure coupled to the third antenna port and optionally e.g. additionally a fourth antenna port and a fourth radiating structure coupled to the fourth antenna port, and so on.

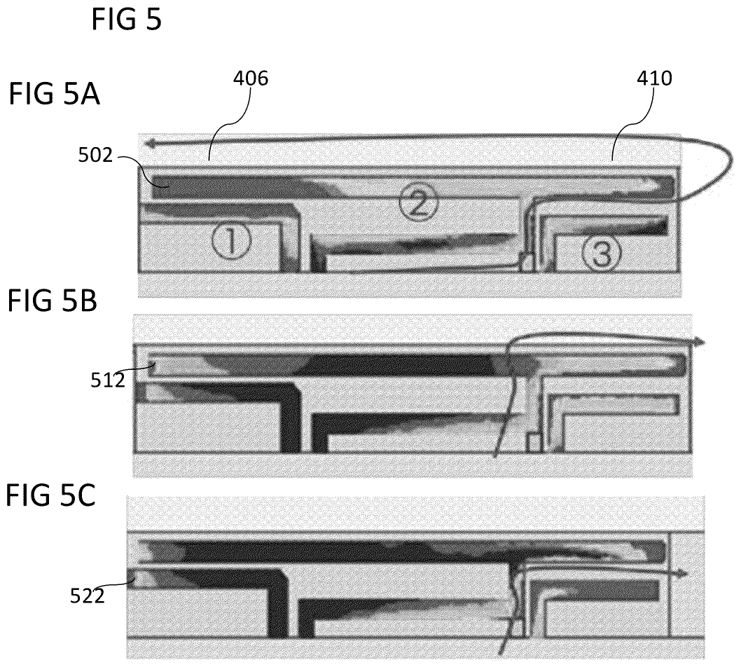

The principle of operation and the role of every metallic element in the design of the multi-feed antenna structure 400 is shown in FIG. 5A to FIG. 5C with a corresponding E-field distribution at LB, HB, UHB showing the main resonant part of the design.

FIG. 5A shows the principle of operation and the role of every metallic element in the design of an antenna structure at LB frequency of 2.45 GHz. The E-field distribution at LB is designated with reference number 502. FIG. 5A shows a resonance at LB frequency of 2.45 GHz.

FIG. 5B shows the principle of operation and the role of every metallic element in the design of the antenna structure at HB frequency of 5.5 GHz. The E-field distribution at HB is designated with reference number 512. FIG. 5B shows a resonance at HB frequency of 5.5 GHz.

FIG. 5C shows the principle of operation and the role of every metallic element in the design of the antenna structure at UHB frequency of 6 GHz. The E-field distribution at UHB is designated with reference number 522. FIG. 5C shows that the bandwidth of the antenna structure increases at UHB frequency of 6 GHz.

The basic isolation mechanism provided is to mirror the radiating structure fed by each port without adding any periodic structure in between. This mechanism leads to around 18 dB isolation level between ports, which may not be sufficient for the corresponding radio architecture. To increase the isolation mechanism, a periodic structure acting as EM metamaterial is illustratively introduced between the two radiating parts of the antenna.

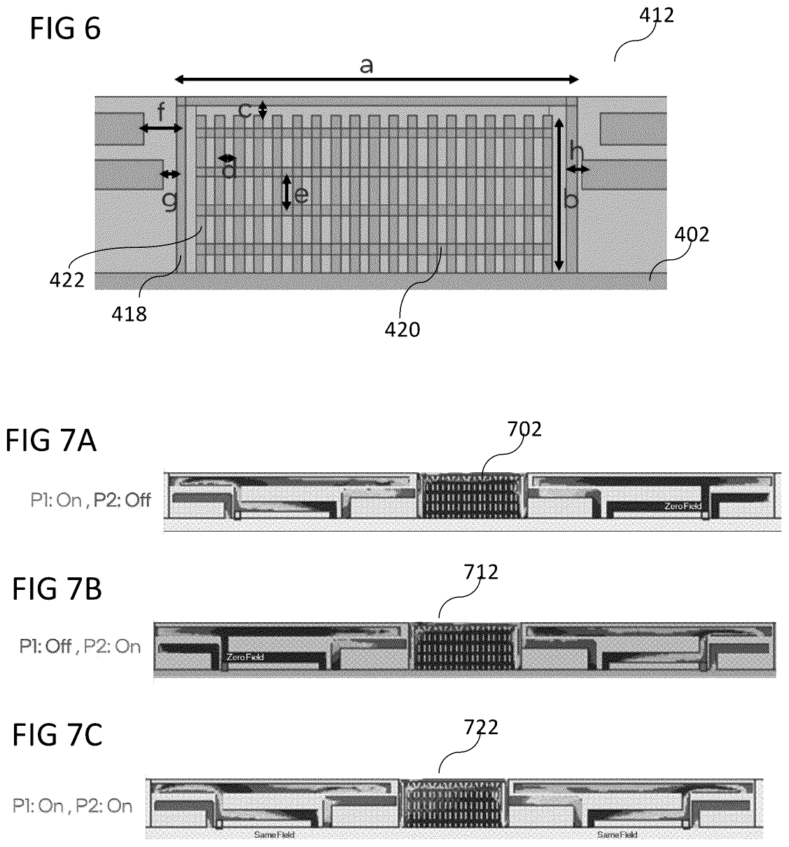

In the following, different suitable parameters of the multi-feed antenna structure (e.g. 400) (see FIG. 6) are provided to ensure a very high isolation level in the HB and UHB which is e.g. generally required in the specification of a dual radio architecture:
Length of frame portion 418-a: approximately λ/5 where λ is the wavelength at the center frequency of the frequency band in which the ports should be highly isolated;
Length of plurality of second electrically conductive lines 422-b: approximately λ/12;
Isolation distance between end of plurality of second electrically conductive lines 422 and nearest part of the frame portion 418-c: approximately λ/250;
Isolation distance between two adjacent second electrically conductive lines 422 of the plurality of second electrically conductive lines 422-d: approximately λ/210;
Isolation distance between two adjacent first electrically conductive lines 420 of the plurality of first electrically conductive lines 420-e: approximately λ/95;
Smallest isolation distance between a first substructure of the first radiating structure and the frame portion 418-f: approximately λ/60;
Smallest isolation distance between a second substructure of the first radiating structure and the frame portion 418-g: approximately λ/147;
Smallest isolation distance between a substructure of the second radiating structure and the frame portion 418-h: approximately λ/357.

It is to be noted that the electromagnetic metamaterial structure 412 of FIG. 4A is not a classical or typical EM metamaterial structure. Various aspects of this disclosure solve different challenges with this structure design:
1) Not enough space to avoid truncation of periodicity required in this kind of structure:
   By way of example, the central frequency of the rejected frequency band may be around 6 GHz, i.e. a wavelength of 5 cm, while the length of this structure is around a=10 mm which is equivalent to around λ/5. In general, this would not be enough for a classical electromagnetic band gap structure to behave as expected from the periodicity.
2) Large bandwidth of operation:
   The structure should ensure frequency band rejection over the bandwidth from 5 GHz to 7.2 GHz, i.e. around 32% of relative bandwidth which is very challenging for a classical electromagnetic band gap structure.
3) No clear wave mode type:
   In general, the design of a classical electromagnetic metamaterial structure requires an assumption about the EM mode (TE, TM) type to which this electromagnetic metamaterial structure is exposed. In various aspects of this disclosure, due to small space, and the topology of the antenna, there is no defined type of wave mode. Therefore, some parts of the antenna elements themselves are part of electromagnetic metamaterial structure macroscopic resonance.

The qualitative behavior of the isolation phenomena is shown in FIG. 7A to FIG. 7C showing the E-field distribution when one or the other of the antenna ports 404, 408, are excited and when both are also excited. It also shows that when the two ports are excited, the field distribution at each radiating element acts as the other port is not operational. The periodic structure is resonating in all cases and absorbing the current to the ground plane. FIG. 7A shows a first E-field distribution 702 demonstrating that when the first antenna port P1 404 is excited the second antenna port P2 408 is located in an area where the coupled E-field is very small or negligible. FIG. 7B shows a second E-field distribution 712 demonstrating that when the second antenna port P2 408 is excited and the first antenna port P1 404 is located in an area where the coupled E-field is very small or negligible. FIG. 7C shows a third E-field distribution 722 demonstrating that when the first antenna port P1 404 is excited and the second antenna port P2 408 is also excited the same individual field distribution is observed for both radiating elements 406, 410.

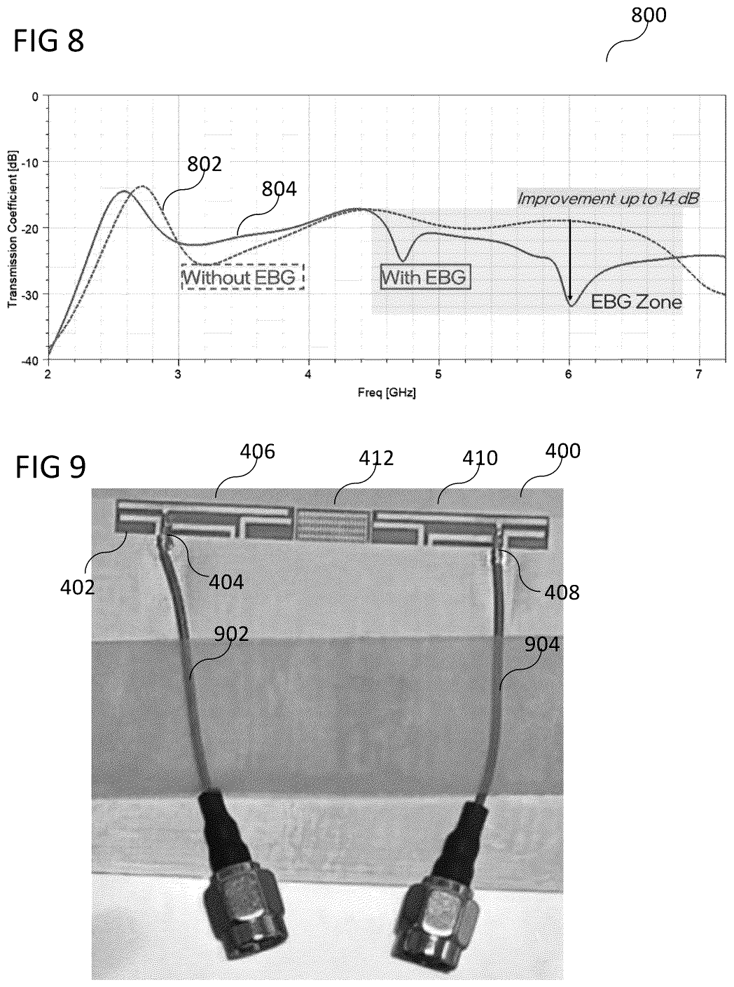

FIG. 8 shows a transmission coefficient vs frequency diagram 800 for a multi-feed antenna structure with an electromagnetic metamaterial structure (see first characteristic 802) and a multi-feed antenna structure without an electromagnetic metamaterial structure (see second characteristic 804). The improvement in isolation is thus quantitively shown in FIG. 8 by comparing the feeds isolation level over the 5 GHz to 7 GHz bandwidth. FIG. 8 shows that the isolation mechanism may improve isolation by up to 14 dB to exceed 30 dB at some frequencies while remaining below 25 dB over HB, and UHB.

FIG. 9 shows the multi-feed antenna structure 400 of FIG. 4A together with two coaxial cables 902, 904 connected to the antenna ports 404, 408, respectively. In more detail, FIG. 9 shows a first coaxial cable 902 electrically conductively coupled to the first antenna port 404 and a second coaxial cable 904 electrically conductively coupled to the second antenna port 410.

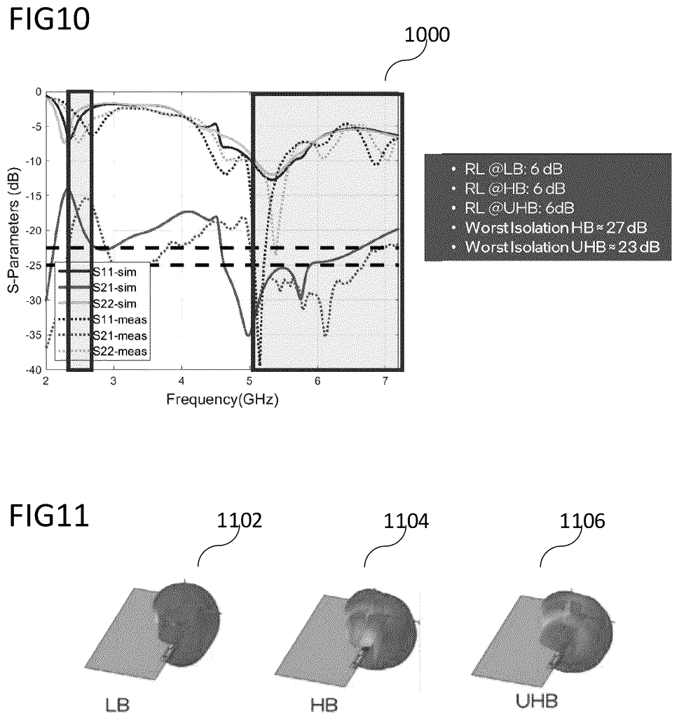

The corresponding antenna reflection coefficients are presented in FIG. 10 as well as the isolation (inverse of the transmission coefficient) between the two feeds (see diagram 1000). A comparison between simulation and measurement is also performed. FIG. 10 shows that the antenna covers the expected Wi-Fi LB, HB, UHB with Return Loss (RL) better than 6 dB and a measured worst isolation of 23 dB in UHB, and 27 dB in HB.

Antenna radiation characteristics are presented in FIG. 11 with 3D patterns for Port 1 (first antenna port 404) taken as example. FIG. 11 shows the quasi-omnidirectional shape of the radiation pattern. In more detail, FIG. 11 shows first antenna radiation characteristics 1102 for the first radiating structure 406 at LB, second antenna radiation characteristics 1104 for the first radiating structure 406 at HB, and third antenna radiation characteristics 1106 for the first radiating structure 406 at UHB.

In summary, various aspects of this disclosure provide:
a compact dual-feed solution with such high isolation over large bandwidth;
an isolation technique composed by metamaterial based on a non-conventional EM metamaterial structure because of:
   the limited size compared to the wavelength;
   the antenna is a part of periodic structure, i.e. the radiating elements are part of the metamaterial resonance (participate to the metamaterial excitation modes) and at the same time the metamaterial structure is a part of the antenna, i.e. it may impact the matching and radiation characteristics;
all the above is achieved in a low-cost high-volume manufacturable solution;
this dual-feed antenna provides the flexibility to be used as single or dual-radio as desired;
this solution allows better control features like time averaging SAR, sensing, and give the opportunities to add more features like ranging, AoA/AOD directionality detection, wellness monitoring, etc.;
the antenna structure is extendible to multi-feed antenna architecture with more than two antenna ports; this flexibility enables the development of more advanced future wireless solutions, e.g. 3×3 MIMO, additional antenna port for Bluetooth (BT), etc.

Another multi-feed antenna structure providing a high isolation between the feeds (i.e. between the antenna ports) will now be described in more detail.

Compared to the conventional dual-linear-polarized antennas, the high isolation multi-feed antenna structure with dual feed configuration provides a high isolation greater than 40 dB over the broadband of HB/UHB (5 GHz to 7 GHZ).

This 40 dB isolation enables a High-Performance Low-Cost (>30% lower than alternative) Dual-Radio Connectivity (WiFi/BT) product (WiFi7 MLO—Multi-Link Operation), supporting improved throughput and latency.

A conventional multi-feed antenna structure usually provides only 15 dB to 20 dB isolation which requires expensive filters between Tx/Rx chains (plus bypass RF switches) which also induces higher insertion loss, thus degrading performance.

Employed antenna combination of slot antenna and Near-Field Resonant Parasitic (NFRP) antenna with orthogonal polarization to each other in a compact structure is provided in various aspects of this disclosure. Symmetricity of the antenna design improves the isolation. The antennas can be enclosed in a metal cavity so that the antennas are affected minimally by materials nearby-important for integration in a common platform.

With a co-design of the antenna pairs, the antenna isolation can be achieved >40 dB in a compact and collocated antenna structure even with very close proximity to the metal cavity, as will described in more detail below.

Various aspects provide an antenna design that can be fed with simple coaxial cables with a low-cost soldering process. The antenna elements can be manufactured with low-cost stamped metals.

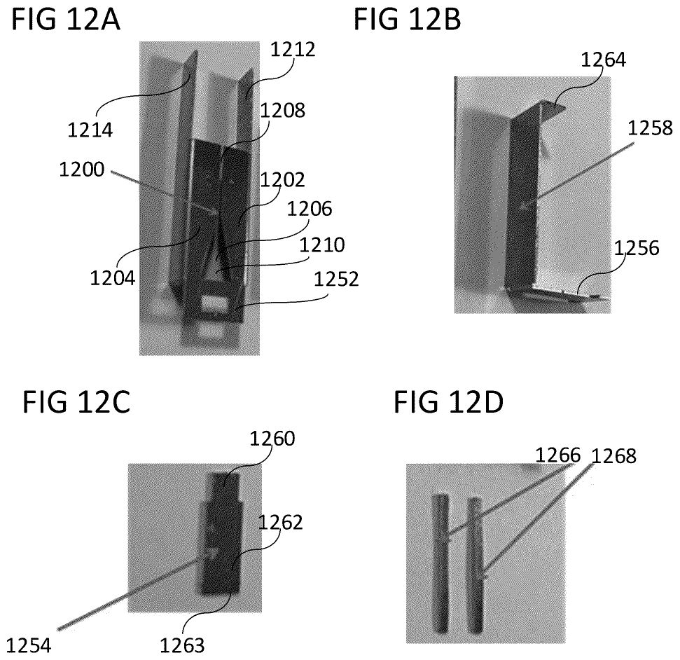

In various aspects of this disclosure, a multi-feed antenna structure may include a (e.g. half) slot antenna 1200 (FIG. 12A) and a Near-Field Resonant Parasitic, NFRP, antenna 1250 (FIG. 12B, FIG. 12C, FIG. 12D).

The slot antenna 1200 may include a first slot antenna portion 1202, a second slot antenna portion 1204 and a slot 1206 separating the first slot antenna portion 1202 and the second slot antenna portion 1204 from each other. In an exemplary implementation, the first slot antenna portion 1202 and the second slot antenna portion 1204 are positioned relative to each other to form different portions having various gaps of different shape forming the slot of the slot antenna 1200, e.g. a substantially rectangular slot portion 1208 and a tapered slot portion extending 1210 from the substantially rectangular slot portion 1208. Furthermore, the slot antenna 1200 may further include a ground structure 1212, 1214 electrically conductively coupled to the first slot antenna portion 1202 and the second slot antenna portion 1204. By way of example, the ground structure 1212, 1214 may include a first (e.g. metal) portion (e.g. plate) 1212 electrically conductively coupled to the first slot antenna portion 1202 and a second (e.g. metal) portion (e.g. plate) 1214 electrically conductively coupled to the second slot antenna portion 1204.

FIG. 12A further shows a feed portion 1252 for the NFRP antenna 1250 which will be described in more detail below.

The NFRP antenna 1250 may include a first NFRP antenna portion 1254 (FIG. 12C), a second NFRP antenna portion 1256 and a third NFRP antenna portion 1258 (FIG. 12B) electrically conductively coupled to the second NFRP antenna portion 1256. The first NFRP antenna portion 1254 is positioned at an angle (e.g. perpendicular) to the slot antenna 1200, e.g. to a main surface of the first slot antenna portion 1202 and the second slot antenna portion 1204. The second NFRP antenna portion 1256 is positioned at an angle (e.g. perpendicular) to the slot antenna 1200, e.g. to a main surface of the first slot antenna portion 1202 and the second slot antenna portion 1204. The third NFRP antenna portion 1258 is positioned at an angle (e.g. perpendicular) to the second NFRP antenna portion 1256. The first NFRP antenna portion 1254 may have a smaller mounting region 1260 and a larger region 1262. Furthermore, the first NFRP antenna portion 1254 may have an extension portion 1263 extending from an end of the larger region 1262 opposite the mounting region 1260. The extension portion 1263 may extend with an angle (e.g. perpendicular) from the end of the larger region 1262. Furthermore, FIG. 12B shows an additional optional extension region 1264 being coupled to the third NFRP antenna portion 1258 with an angle (e.g. perpendicular). FIG. 12D shows a fourth NFRP antenna portion 1266, 1268 including a first connecting portion 1266 and a second connecting portion 1268.

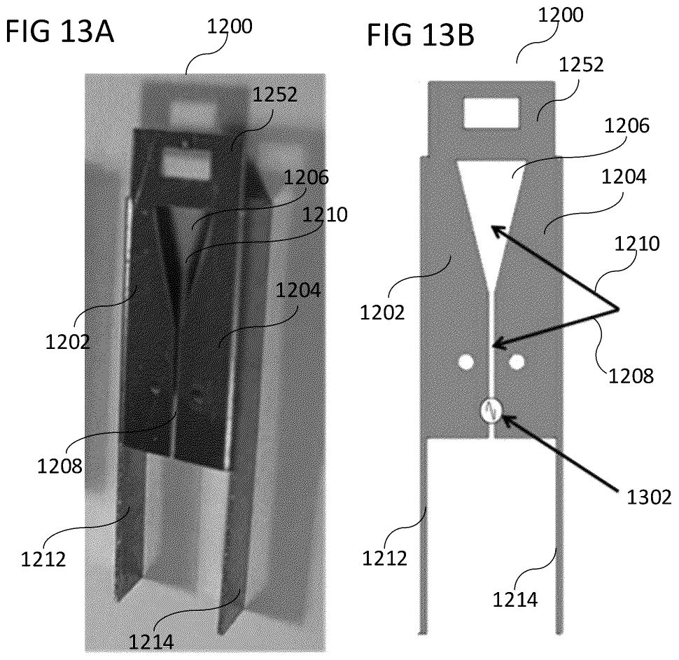

FIG. 13A shows a top side view and FIG. 13B shows a top view of the slot antenna 1200 of a multi-feed antenna structure in accordance with various aspects of this disclosure. As shown in FIG. 13B, a first antenna port 1302 (also referred to as a voltage gap source) is provided between the first slot antenna portion 1202 and the second slot antenna portion 1204. To feed an RF signal into the slot antenna 1200, a first RF potential of the RF signal is applied to the first slot antenna portion 1202 and a second RF potential of the RF signal is applied to the second slot antenna portion 1204. To do this, one or more cables may be provided, e.g. a coaxial cable. By way of example, a cable outer connector of the coaxial cable is coupled to the first slot antenna portion 1202 (or to the second slot antenna portion 1204) and a cable inner connector of the coaxial cable is coupled to the second slot antenna portion 1204 (or to the first slot antenna portion 1202).

A radio signal received by the slot antenna 1200 may be received by the cables, e.g. the coaxial cable, in an analog manner.

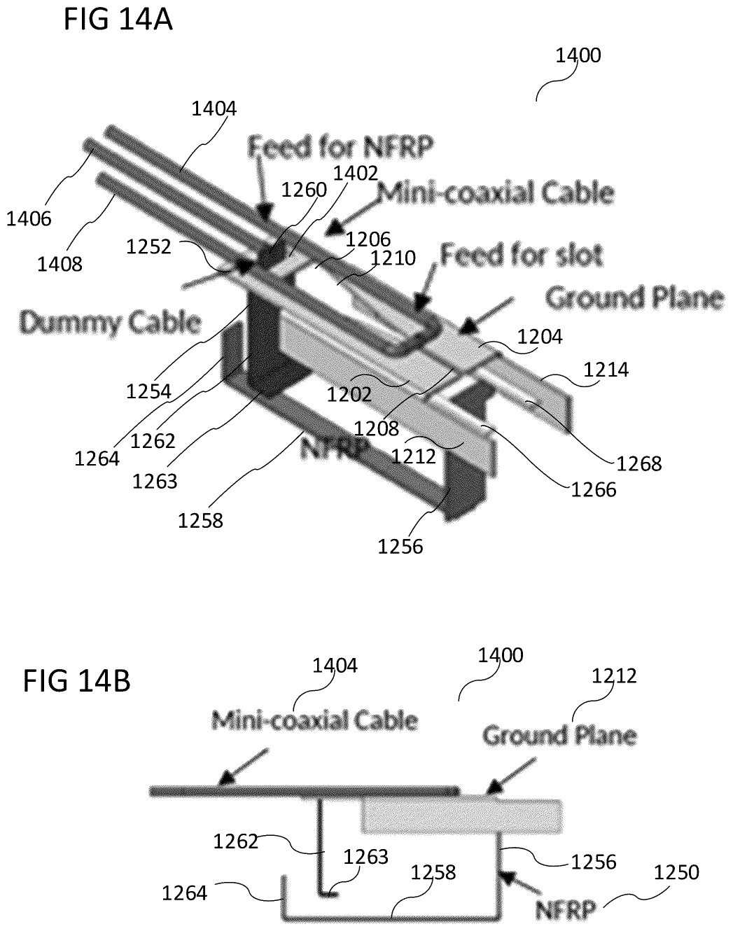

FIG. 14A shows a top side view and FIG. 14B shows a side view of an assembled multi-feed antenna structure 1400 in accordance with various aspects of this disclosure.

As shown in FIG. 14A, the smaller mounting region 1260 may be inserted into an opening 1402 of the feed portion 1252 and fixed, e.g. soldered, to the feed portion 1252, thereby fixed to the slot antenna 1200. The mounting region 1260 may be inserted into the opening 1402 with an angle (e.g. perpendicular) to the main surface of the first slot antenna portion 1202 and the second slot antenna portion 1204. In other words, the first NFRP antenna portion 1254 may extend with an angle (e.g. perpendicular) from the slot antenna 1200, e.g. from the main surface of the first slot antenna portion 1202 and the second slot antenna portion 1204.

An end of the second NFRP antenna portion 1256 may be fixed (e.g. soldered) to the fourth NFRP antenna portion 1266, 1268. By way of example, the end of the second NFRP antenna portion 1256 may be fixed (e.g. soldered) to the first connecting portion 1266. Furthermore, the end of the second NFRP antenna portion 1256 may also be fixed (e.g. soldered) to the second connecting portion 1268.

The third NFRP antenna portion 1258 extends towards the first NFRP antenna portion 1254 substantially parallel with the extension portion 1263. Furthermore, the third NFRP antenna portion 1258 extends below the first NFRP antenna portion 1254 and the extension portion 1263 without any physical contact to either of them. The additional optional extension region 1264 may extend towards the slot antenna 1200.

The mounting region 1260 may serve as a feed port for the NFRP antenna 1250.

FIG. 14A further shows a coaxial cable (e.g. a mini-coaxial cable) 1404 coupled to first antenna port to feed the slot antenna 1200 as described above. A further cable 1406 may be provided coupled to the mounting region 1260 of the NFRP antenna 1250 to feed the NFRP antenna 1250. Illustratively, the feed portion 1252 serves as an NFRP antenna feed portion configured to receive Near-Field radio signals. The NFRP antenna feed portion 1252 includes an opening 1402 to feed the NFRP antenna 1250 on the same plane with the slot antenna 1200. The opening 1402 is capacitively coupled with the first slot antenna portion 1202, the second slot antenna portion 1204 and the first NFRP antenna portion 1254. The opening 1402 may include or be a rectangular opening 1402.

In this compact exemplary design, the slot antenna 1200 and the NFRP antenna 1250 are configured to have orthogonal polarization to each other.

Moreover, the multi-feed antenna structure may further include a dummy wire 1408 (e.g. a dummy cable 1408) electrically conductively coupled to the slot antenna 1200. The RF connector (e.g. the coaxial cable 1404) and the dummy wire 1408 may be positioned mirrored to each other; for example positioned axis symmetrically to each other with the center of the slot 1206 being the axis of symmetry. The dummy wire 1408 (e.g. the dummy cable 1408) may act like a balun balancing the currents between the first slot antenna portion 1202 and the second slot antenna portion 1204 to maintain orthogonality with NFRP antenna 1250, thereby achieving a high isolation (>40 dB) between the slot antenna 1200 and the NFRP antenna 1250. In various aspects of this disclosure, the dummy wire 1408 may be configured as a dummy metallic rod structure, e.g. having the same diameter with that of the cable outer conductor of the coaxial cable 1404.

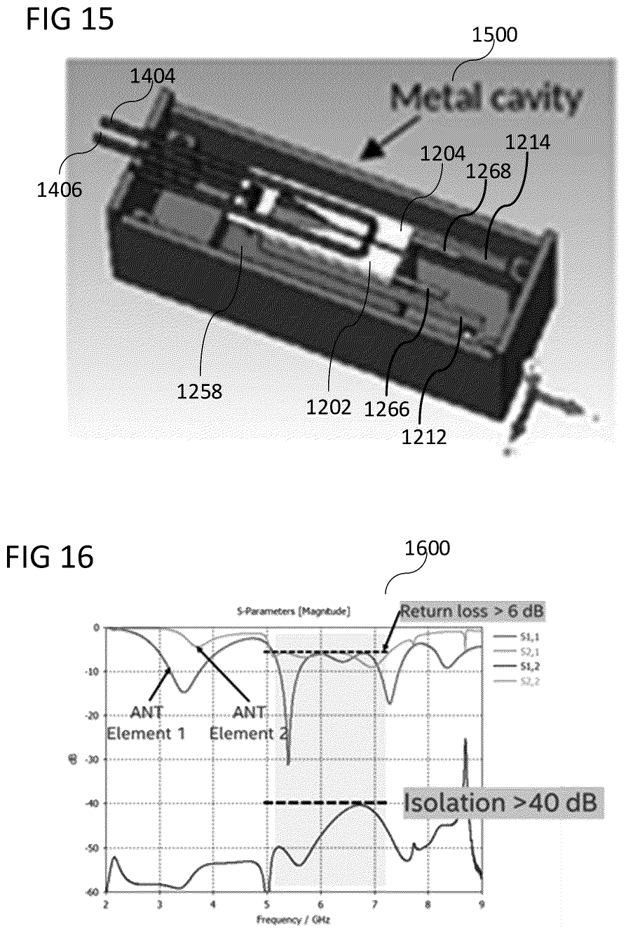

As shown in FIG. 15, the multi-feed antenna structure may further include a cavity 1500, e.g. a metal cavity 1500. The slot antenna 1200 and the NFRP antenna 1250 may be located or positioned within the cavity 1500. The cavity 1500 may include or be formed by a metal.

The multi-feed antenna structure may be configured to provide an isolation of at least 35 dB, e.g. at least 40 dB, between the slot antenna 1200 and the NFRP antenna 1250 (e.g. an isolation in the range from about 30 dB to about 50 dB, e.g. in the range from about 35 dB to about 48 dB, e.g. in the range from about 40 dB to about 45 dB).

In various aspects, the multi-feed antenna structure may be configured to provide the above isolations between the slot antenna 1200 and the NFRP antenna 1250 over a frequency band from about 5 GHz to about 7 GHz.

As described above, illustratively, the antenna structure may be composed of the (half-) slot antenna 1200 and the NFRP antenna 1250. The (half-) slot antenna 1200 and the NFRP antenna 1250 are placed in a top-down configuration sharing the antenna ground structure in a compact form factor. The (half-) slot antenna 1200 and the NFRP antenna 1250 may be fed with standard mini-coaxial cables soldered on the common antenna ground structure that was designed for easy soldering without any expensive connector required. The dummy wire or dummy cable for the slot is included to create symmetric design that provides for a high isolation.

The slot antenna 1200 is provided at the top of the antenna structure and the NFRP antenna 1250 is provided at the bottom near the metal cavity 1500, since the NFRP antenna 1250 is less susceptible to metal than the slot antenna 1200.

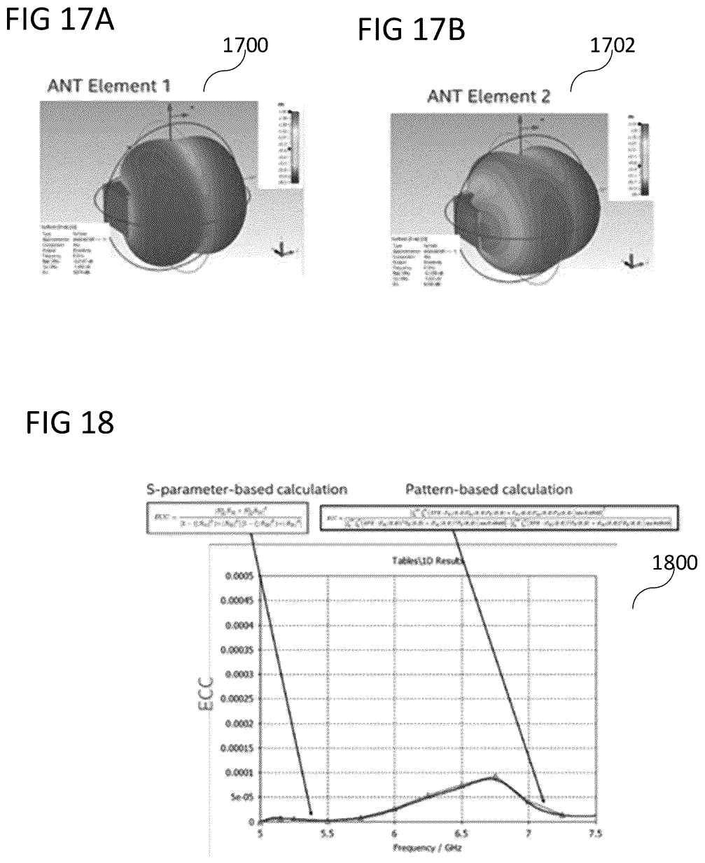

FIG. 16 shows a diagram 1600 illustrating the characteristics of the antennas calculated in CST MICROWAVE STUDIO (CST MWS). Simulation results show that the antenna isolation is >40 dB with >6 dB return loss over HB/UHB. FIG. 17A and FIG. 17B show calculated antenna radiation patterns 1700, 1702 of the multi-feed antenna structure of FIG. 15 and FIG. 18 shows an envelope correlation coefficient (ECC) in a diagram 1800.

As mentioned above, it is challenging to design a multi-feed antenna structure placing multiple antennas at different locations in base due to RF window requirements. By way of example, for next generation WLAN/WWAN (Wireless Wide Area Network) applications, more antennas will be required to support M×N MIMO radio configuration to enhance date rate. If the antennas are placed close to each other, it may yield poor isolation, which causes a drop in wireless throughput. Further, the implementation of e.g. PCB antennas on a system base of the system (in other words the multi-feed antenna structure) asks for large plastic cut-out.

Large metal cutout (plastic), however, may not be acceptable from ID (industrial design) perspective because of the compromise with seamless design. In various aspects of this disclosure, dual feed WLAN antennas provide high isolation (>25 dB), even if placing the antennas adjacent to each other. In general, the antenna performance (mainly, isolation) deteriorates if antennas are placed very close to each other. Various aspects of this disclosure allow dual fed antennas (or multi-feed antennas in general) within the same KOZ (keep out zone) to work with very good isolation for the next generation WLAN technology.

Various exemplary implementations of a multi-feed antenna structure may address one or more of the following:
the isolation issue between two antennas, if they are placed very close to each other without degrading antenna efficiency;
the multi-feed antenna structure can be used as M×N MIMO configuration for next generation high speed WLAN applications as having very good isolation in the range of ˜25 dB;
more antennas may be placed close to each other and hence can be fixed in the same KOZ with a single RF window; this may give ID benefit;
the multi-feed antenna structure may improve the isolation between adjacent antennas without more physical separation;
multiple antennas in a single RF window/position; avoids scattered antenna placement;
single EMC/RFI solution for all antennas of the multi-feed antenna structure;
two antennas usually require a physical distance to meet isolation resulting in more spacing or scattered antenna placement in a system requires multiple keep out zone or RF non-metallic windows; and/or
closely placed antenna solutions with isolation in the range of −15 dB is conventionally available but that solution is not sufficient to achieve −25 dB isolation at WLAN 2.4 GHz to 2.5 GHz and 5 GHz to 7.125 GHz frequency bands.

When two antennas placed very close, then the isolation between the antennas may becomes very poor and it may effect a wireless performance (throughput). To improve the antenna performance with placing two or more in adjacent location, various aspects of this disclosure are provided, in which the antennas are placed very close, these antennas may be referred to as dual feed antennas.

Illustratively, in various aspects of this disclosure, a circuit with grounded shunt components are placed in between the antennas of the multi-feed antenna structure along with a ground etching between the antennas. This may help in getting very good isolation in the range of ˜25 dB. This may achieve implementing an M×N MIMO configuration in a compact PC system with antennas placed very close to each other.

Various aspects may provide a multi-feed antenna structure with a high isolation—this may reduce diplexers in upcoming WLAN SOC design that will help to reduce SOC cost for MIMO WLAN.

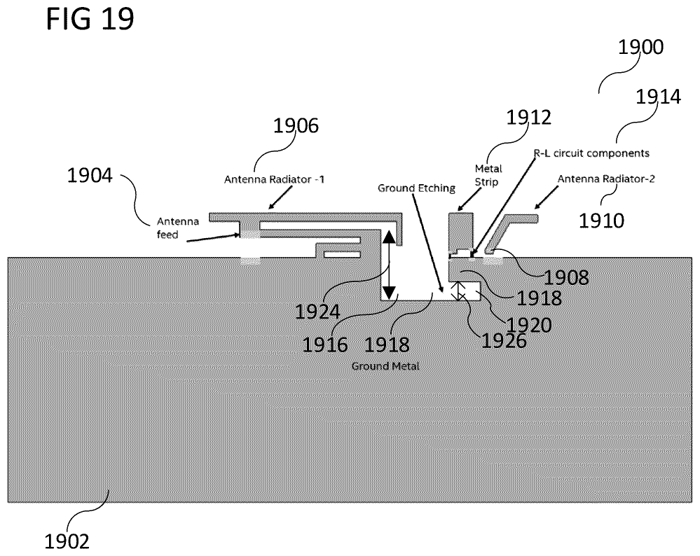

FIG. 19 shows a multi-feed antenna structure 1900 in accordance with various aspects of this disclosure.

The multi-feed antenna structure 1900 may include a grounding structure 1902, e.g. a metal carrier or metal substrate. The grounding structure 1902 may be configured as a metal block. The metal may be or include Cu, Ag, Au, and the like. However, the grounding structure may be a part of a carrier that also includes electrically insulating material. The multi-feed antenna structure 1900 may further include a first antenna port 1904 (also referred to as a first antenna feed) and a first radiating structure 1906 coupled to the first antenna port 1904 and mounted on the grounding structure 1900 (or monolithically integrated with the grounding structure 1900). The multi-feed antenna structure 1900 may further include a second antenna port 1908 (also referred to as a second antenna feed) and a second radiating structure 1910 coupled to the second antenna port 1908 and mounted on the grounding structure 1900 (or monolithically integrated with the grounding structure 1900).

The multi-feed antenna structure 1900 may further include an electrically conductive isolation portion 1912 positioned between the first radiating structure 1906 and the second radiating structure 1910. The electrically conductive isolation portion 1912 may be or include a metal strip positioned close to the second radiating structure 1910. The electrically conductive isolation portion 1912 is coupled to the grounding structure 1902 via a filter structure 1914. The filter structure 1914 may include one or more resistors (R), one or more capacitors (C) and/or one or more inductors (L) (e.g. any desired number of R-L circuit components) connected between the electrically conductive isolation portion 1912 and the grounding structure 1902. The values of the components of the filter structure 1914 depend on the concrete structures of the other components of the multi-feed antenna structure 1900 and will be determined for each design individually. The multi-feed antenna structure 1900 may further include a cutout 1916 in the grounding structure 1902, wherein the cutout 1916 extends from or between the first radiating structure 1906 and the second radiating structure 1910 and below the electrically conductive isolation portion 1912. The cutout 1916 may be formed by means of an etch process. In an exemplary implementation, the cutout 1916 may also be referred to as a ground etching structure 1916.

The electrically conductive isolation portion 1912 may be mounted on a mounting portion 1918 of the grounding structure 1902. The mounting portion 1918 may extend over the cutout 1916. The mounting portion 1918 may be located on the same side of the cutout 1916 as the second radiating structure 1910. The first radiating structure 1906 may be positioned at the opposite side of the cutout 1016.

In various aspects of this disclosure, the first radiating structure 1906 is configured to resonate in a frequency range from about 2.4 GHz to about 2.5 GHz and from about 5.1 GHz and about 7.125 GHz. Furthermore, the second radiating structure 1910 may be configured to resonate in a frequency range from about 5.1 GHz and about 7.125 GHz. By way of example, for a first multi band antenna (as an example of the first radiating structure) and a second antenna (as an example of the second radiating structure), an isolation circuit can be extended between multiple and multi-band antennas to achieve better isolation among them. As an example shown here for 2.4 GHz to 2.5 GHz and 5-7.125 GHz, etc. It is to be noted that the isolation circuit may be used between any two antennas.

In other words, FIG. 19 shows the multi-feed antenna structure 1900 where two WLAN antennas, a left side antenna (e.g. first radiating structure 1906) may be design to resonate at 2.4 GHz to 2.5 GHz and at 5.1 GHZ to 7.125 GHz and the right side antenna (e.g. second radiating structure 1910) may be designed to cover only 5.1 GHz to 7.125 GHz frequency bands. The isolation mechanism that includes the metal partition strip 1912 (as one example implementation of the electrically conductive isolation portion 1912) is inserted between the antennas 1906, 1910. The metal partition strip 1912 is further grounded via e.g. an R-L filter circuit 1914. FIG. 19 also shows the ground etching 1916 between one of the antennas (e.g. first radiating structure 1906) and the metal partition strip 1912.

The electrically conductive isolation portion 1912 (e.g. the metal partition strip 1912) together with the filter structure 1914 (e.g. the R-L filter 1914) that connects to ground (in general to a reference potential) and the cutout 1916 (e.g. the ground etching 1916) achieve a dual feed antenna with a high isolation. These two antennas 1906, 1910 can be either have the same frequency band or can have different frequency bands. It is to be noted that the isolation portion 1912 may be applied between two or more antennas.

The first antenna port 1904 and the second antenna port 1908 may be positioned at a distance of at least about 25 mm from each other, e.g. at a distance of at least about 30 mm, e.g. at a distance of at least about 40 mm, e.g. at a distance in the range from about 20 mm to about 90 mm, e.g. at a distance in the range from about 25 mm to about 70 mm, e.g. at a distance in the range from about 30 mm to about 60 mm, e.g. at a distance in the range from about 25 mm to about 45 mm. However, it is to be noted that the antenna ports 1904, 1908 may be positioned as close as possible based on requirements and isolation that can be achieved.

As shown in FIG. 19, the cutout 1919 may have a first cutout portion 1920 and a second cutout portion 1922. The first cutout portion 1920 may extend laterally from the first radiating structure 1906 to the mounting portion 1918 of the grounding structure 1902. The second cutout portion 1922 may extend from one end of the mounting portion 1918 facing the first cutout portion 1920 to the second radiating structure 1910. It is to be noted that in general any number of cutout portions 1920, 1922 may be provided, e.g. three, four, five, six, seven, eight or even more.

The first cutout portion 1920 may have a lateral extension from the first radiating structure 1906 (e.g. an end or edge of the first radiating structure 1906 facing the cutout 1916) to the mounting portion 1918 of the grounding structure 1902 (e.g. an end or edge of the mounting portion 1918 facing the cutout 1916) in the range from about 8 mm to about 9 mm, e.g. in the range from about 8.25 mm to about 8.75 mm. The lateral extension of the first cutout portion 1920 may be subject of optimization and it may depend on how much isolation is required or desired in a specific design.

The second cutout portion 1922 may have a lateral extension from the mounting portion 1918 of the grounding structure 1902 (e.g. an end or edge of the mounting portion 1918 facing the cutout 1916) to the first radiating structure 1906 (e.g. an end or edge of the first radiating structure 1906 facing the cutout 1916) in the range from about 3 mm to about 5 mm, e.g. in the range from about 3.5 mm to about 4.5 mm. The lateral extension of the second cutout portion 1922 may be subject of optimization and it may depend on how much isolation is required or desired in a specific design.

Furthermore, the first cutout portion 1920 may have a depth (symbolized in FIG. 19 by a first double arrow 1924) in the range from about 4 mm to about 6 mm, e.g. in the range from about 4.5 mm to about 5.5 mm. The depth of the first cutout portion 1922 may be subject of optimization and it may depend on how much isolation is required or desired in a specific design. The second cutout portion may have a depth (symbolized in FIG. 19 by a second double arrow 1926) in the range from about 2 mm to about 3 mm, e.g. in the range from about 2.25 mm to about 2.75 mm. The depth of the second cutout portion 1922 may be subject of optimization and it may depend on how much isolation is required or desired in a specific design.

The multi-feed antenna structure may be configured to provide at least 20 dB isolation between the first radiating structure 1906 and the second radiating structure 1910.

In the following, the effects provided by the multi-feed antenna structure 1900 of FIG. 19 will be explained step-by-step:

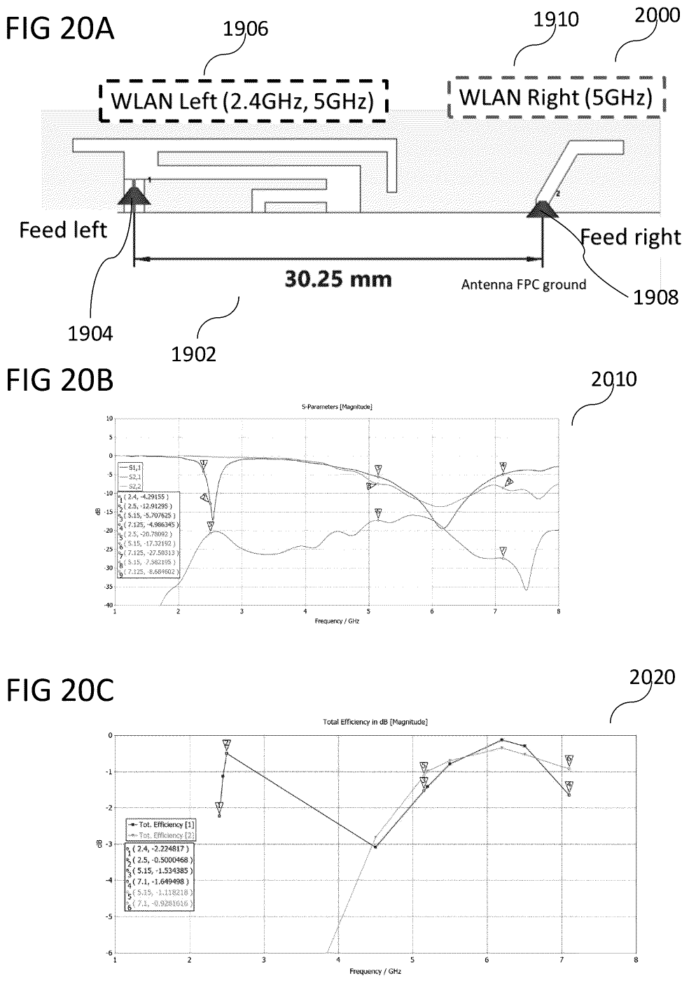

FIG. 20A to FIG. 20C show a structure 2000 of two WLAN antennas placed nearby without any isolation circuit or ground etching as a reference case (FIG. 20A) and a corresponding S-parameter diagram 2010 (FIG. 20B) and a corresponding antenna efficiency diagram 2020 (FIG. 20C);

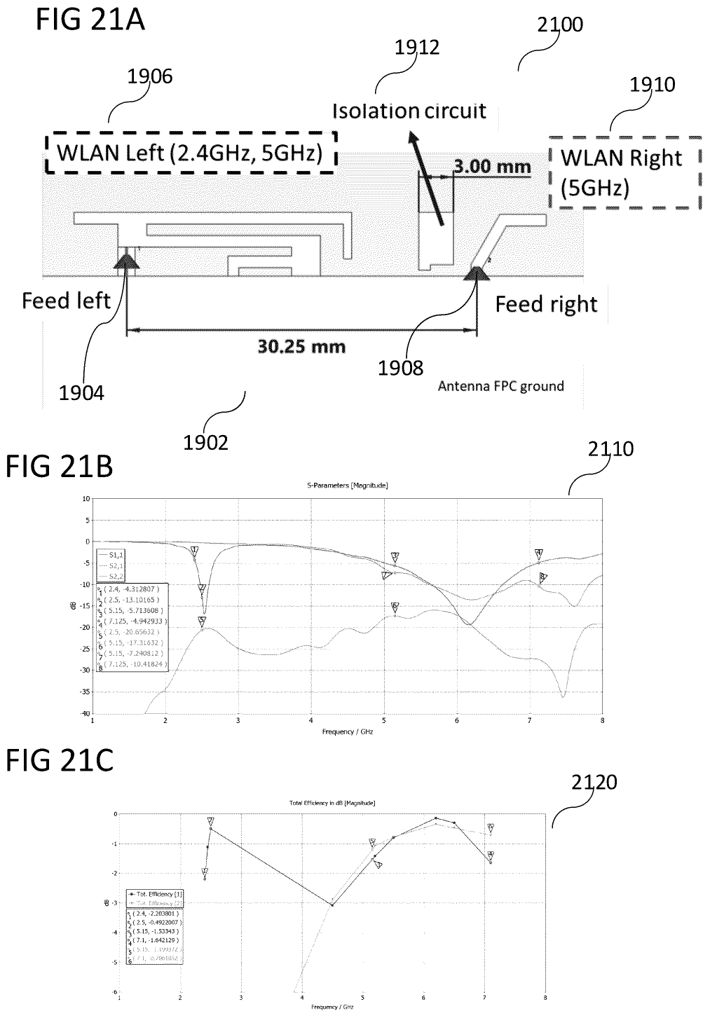

FIG. 21A to FIG. 21C show a structure 2100 of two WLAN antennas placed nearby with an electrically conductive isolation portion 1912 (illustratively with a metal trace between the antennas 1906, 1910), but without a ground etching (FIG. 21A) and a corresponding S-parameter diagram 2110 (FIG. 21B) and a corresponding antenna efficiency diagram 2120 (FIG. 21C).

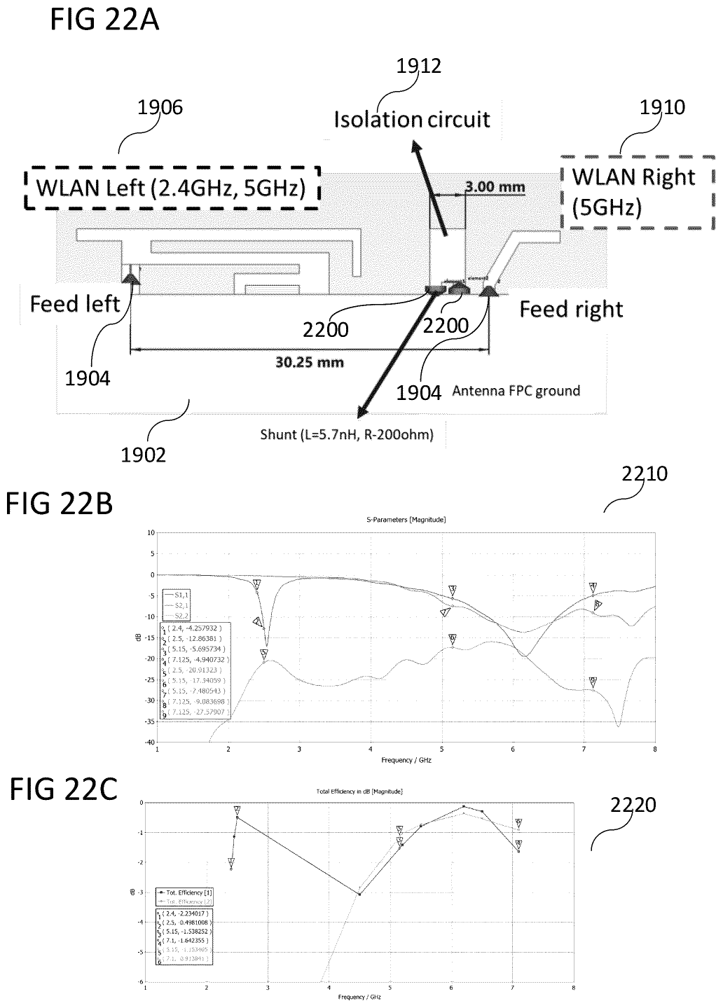

FIG. 22A to FIG. 22C show two WLAN antennas placed nearby with shunt components 2200 between the antennas 1906, 1910, but without a ground etching 1916 (FIG. 22A) and a corresponding S-parameter diagram 2210 (FIG. 22B) and a corresponding antenna efficiency diagram 2220 (FIG. 22C).

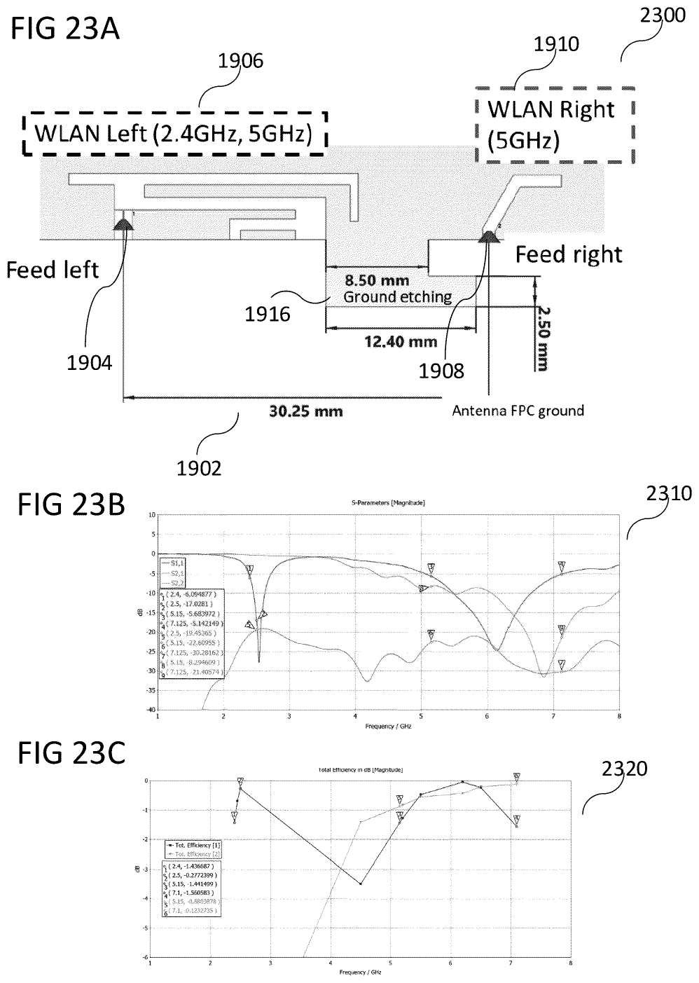

FIG. 23A to FIG. 23C show a structure 2300 of two WLAN antennas 1906, 1910 placed nearby with only a ground etching 1916 between the antennas 1906, 1910 (FIG. 23A) and a corresponding S-parameter diagram 2310 (FIG. 23B) and a corresponding antenna efficiency diagram 2320 (FIG. 23C).

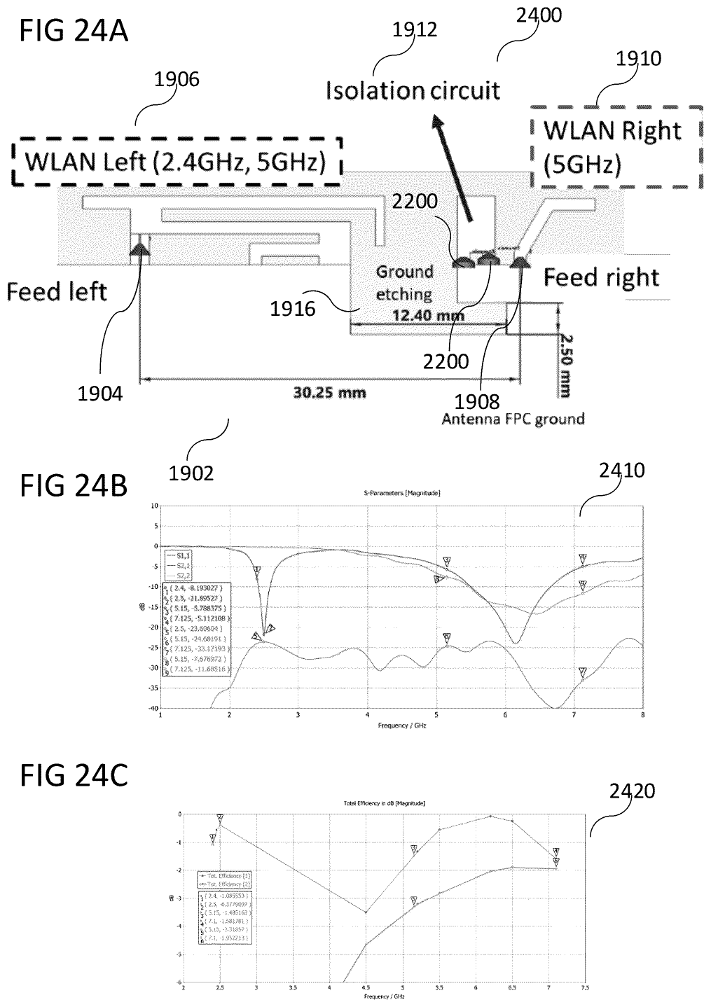

FIG. 24A to FIG. 24C show a structure 2400 of two WLAN antennas placed nearby with an electrically conductive isolation portion and a ground etching between the antennas (FIG. 24A) and a corresponding S-parameter diagram 2410 (FIG. 24B) and a corresponding antenna efficiency diagram 2420 (FIG. 24C).

The following table compares the isolation performance of the structures shown in FIG. 20A to FIG. 20C, FIG. 21A to FIG. 21C, FIG. 22A to FIG. 22C, FIG. 23A to FIG. 23C, and FIG. 24A to FIG. 24C:

| | | S₁₂ | S₁₂ |
|---|---|---|---|
| | | (dB) @ | (dB) @ |
| FIGS. | Design Approach | 2.5 GHz | 5 GHz |
| FIG. 20A to FIG. 20C | Reference design without | −20 | −17 |
| | isolation solution | | |
| FIG. 21A to FIG. 21C | Floating metal between | −20 | −17 |
| | antennas | | |
| FIG. 22A to FIG. 22C | Isolation circuit with SMD | −21 | −17 |
| | components | | |
| FIG. 23A to FIG. 23C | Ground etching without | −19 | −22 |
| | isolation | | |
| FIG. 24A to FIG. 24C | Structure with ground | −24 | −25 |
| | etching and isolation | | |
| | circuit | | |

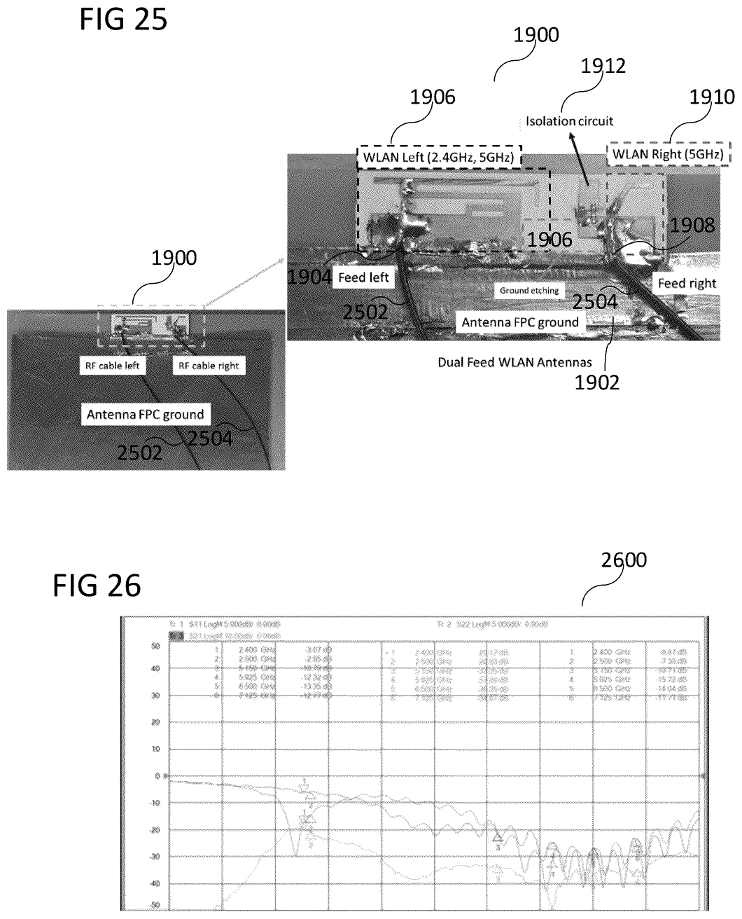

FIG. 25 shows the validation setup that includes the multi-feed antenna structure 1900 having as an exemplary implementation two WLAN antennas, left side WLAN antenna (an example of the first radiating structure 1906) is designed for dual band 2.4 GHz and 5 GHz frequencies. The right-side WLAN antenna (an example of the second radiating structure 1910) is designed for 5 GHz band. The antenna FPCs 1902 are fabricated on the single piece 0.2 mm thick FR4 substrate. The FPCS 1902 are grounded with a wide copper sheet with 300×200 mm². The dual-fed WLAN antennas 1906, 1910 are implemented with the isolation circuit 1912 between the WLAN antennas 1906, 1910 along with ground etching 1916 to achieve very high isolation in the range of 25 dB.

FIG. 26 shows an S-parameter diagram 2600 measured for the validation setup of FIG. 25.

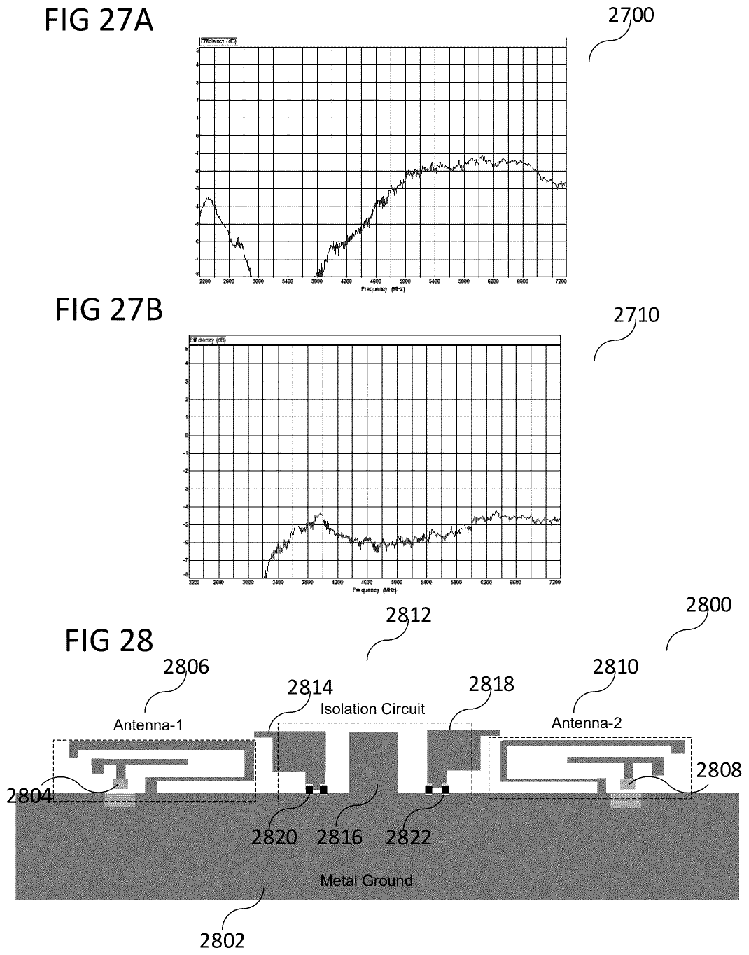

FIG. 27A and FIG. 27B show a first antenna efficiency diagram 2700 (FIG. 27A) for the first radiating structure 1906 and a second antenna efficiency diagram 2710 (FIG. 27B) for the second radiating structure 1910 measured for the validation setup of FIG. 25.

FIG. 28 shows a multi-feed antenna structure 2800 in accordance with various aspects of this disclosure.

The multi-feed antenna structure 2800 may include a grounding structure 2802, a first antenna port 2804 and a first radiating structure 2806. The first radiating structure 2806 is electrically conductively coupled to the first antenna port 2804 and mounted on the grounding structure 2802. The multi-feed antenna structure 2800 may further include a second antenna port 2808 and a second radiating structure 2810. The second radiating structure 2810 is electrically conductively coupled to the second antenna port 2808 and mounted on the grounding structure 2802. The multi-feed antenna structure 2800 may further include an isolation structure 2812 or circuit positioned between the first radiating structure and the second radiating structure. The isolation structure 2812 may include a plurality of electrically conductive isolation portions 2814, 2816, 2818 positioned between the first radiating structure 2806 and the second radiating structure 2810. The plurality of electrically conductive isolation portions 2814, 2816, 2818 may include a first electrically conductive isolation portion 2814 (e.g. implemented as a metal strip or metal block), a second electrically conductive isolation portion 2816 (e.g. implemented as a metal strip or metal block), and a third electrically conductive isolation portion 2818 (e.g. implemented as a metal strip or metal block). The first electrically conductive isolation portion 2814 is positioned between the first radiating structure 2806 and the second electrically conductive isolation portion 2816. The third electrically conductive isolation portion 2818 is positioned between the second radiating structure 2810 and the second electrically conductive isolation portion 2816. The first electrically conductive isolation portion 2814 is coupled to the grounding structure 2802 via a first filter structure 2820 and the third electrically conductive isolation portion 2818 is coupled to the grounding structure 2802 via a second filter structure 2822 (which may be different from the first filter structure 2820, e.g. may have a different resonant frequency than the first filter structure 2820). The second electrically conductive isolation portion 2816 is directly coupled to the grounding structure 2802. In other words, there is no filter structure connected between the second electrically conductive isolation portion 2816 and the grounding structure 2802.

The first filter structure 2820 may include a first resistor-inductor-filter structure 2820. The second filter structure 2822 may include a second resistor-inductor-filter structure 2822. The first radiating structure may be configured to resonate in a frequency range from about 2.4 GHz to about 2.5 GHz and from about 5.1 GHz and about 7.125 GHz. The second radiating structure may be configured to resonate in a frequency range from about 5.1 GHz and about 7.125 GHz. By way of example, for a first multi band antenna (as an example of the first radiating structure 2806) and a second antenna (as an example of the second radiating structure 2810), the isolation circuit 2812 can be extended between multiple and multi-band antennas to achieve better isoattenuation among them. As an example shown here for 2.4 to 2.5 GHz and 5 to 7.125 GHz, etc. It is to be noted that the isolation circuit 2812 may be used between any two antennas. The first antenna port 2804 and the second antenna port 2808 may be positioned at a distance of at least about 25 mm from each other. However, it is to be noted that the antenna ports may be positioned as close as possible based on requirements and isolation that can be achieved. The multi-feed antenna structure may be configured to provide at least 20 dB isolation between the first radiating structure and the second radiating structure.

In other words, a metallic structure 2812 between two or more antennas 2806, 2810 is provided. An isolation circuit/structure 2812 between antenna-1 (an example of the first radiating structure 2806) and antenna-2 (an example of the second radiating structure 2810) is being proposed where the isolation circuit 2812 includes at least three metal strips 2814, 2816, 2818 between the antennas 2806, 2810. The metal strips 2814, 2818 closer to the antennas 2806, 2810 are shorted to the ground 2802 through R-L Filter circuits 2820, 2822. The middle metal strip 2816 is shorted to the ground 2802 directly. The combination of the described isolation metal structure 2812 with filter circuits 2820, 2822 helps to improve isolation by 10 dB to 20 dB in desired frequency bands of the antennas 2806, 2810.

In the following, various aspects of this disclosure will be illustrated:

Example 1A is a multi-feed antenna structure. The multi-feed antenna structure may include a first antenna port; a first radiating structure coupled to the first antenna port; a second antenna port; a second radiating structure coupled to the second antenna port; and an electromagnetic metamaterial structure located between the first radiating structure and the second radiating structure.

In Example 2A, the subject matter of Example 1A can optionally include that the multi-feed antenna structure further includes a carrier. The first antenna port, the first radiating structure, the second antenna port, the second radiating structure, and the electromagnetic metamaterial structure are located on the carrier.

In Example 3A, the subject matter of Example 1A can optionally include that the first radiating structure, the second radiating structure, and the electromagnetic metamaterial structure are printed on the carrier.

In Example 4A, the subject matter of any one of Examples 1A to 3A can optionally include that the metamaterial structure comprises electrically conductive material.

In Example 5A, the subject matter of Example 4A can optionally include that the electromagnetic metamaterial structure includes metal.

In Example 6A, the subject matter of any one of Examples 1A to 5A can optionally include that the electromagnetic metamaterial structure comprises a periodic structure.

In Example 7A, the subject matter of Example 6A can optionally include that the periodic structure includes electrically conductive elements arranged in a periodic distance from each other in at least one direction.

In Example 8A, the subject matter of Example 7A can optionally include that the periodic structure includes a grid structure or an elliptical structure, e.g. a concentric elliptical structure.

In Example 9A, the subject matter of any one of Examples 7A or 8A can optionally include that the electromagnetic metamaterial structure includes a frame surrounding the periodic structure.

In Example 10A, the subject matter of any one of Examples 1A to 9A can optionally include that the electromagnetic metamaterial structure is configured as an electromagnetic filter.

In Example 11A, the subject matter of Example 10A can optionally include that the electromagnetic metamaterial structure is configured as an electromagnetic stopband filter.

In Example 12A, the subject matter of any one of Examples 1A to 11A can optionally include that the multi-feed antenna structure is configured to simultaneously transmit and/or receive radio signals.

In Example 13A, the subject matter of any one of Examples 1A to 12A can optionally include that the multi-feed antenna structure is configured as a Dual-Radio Connectivity antenna structure.

In Example 14A, the subject matter of any one of Examples 1A to 13A can optionally include that the electromagnetic metamaterial structure is configured to provide at least 20 dB isolation between the first radiating structure and the second radiating structure.

In Example 15A, the subject matter of any one of Examples 1A to 14A can optionally include that the multi-feed antenna structure further includes a third antenna port; and a third radiating structure coupled to the third antenna port.

Example 16A is a radio communication device. The radio communication device may include a multi-feed antenna structure of any one of Examples 1A to 15A; and a baseband processor configured to provide signals to the multi-feed antenna structure or to receive signals from the multi-feed antenna structure.

Example 1B is a multi-feed antenna structure. The multi-feed antenna structure may include a slot antenna including a first slot antenna portion, a second slot antenna portion and a slot separating the first slot antenna portion and a second slot antenna portion from each other; a Near-Field Resonant Parasitic, NFRP, antenna comprising a first NFRP antenna portion, a second NFRP antenna portion and a third NFRP antenna portion electrically conductively coupled to the second NFRP antenna portion. The first NFRP antenna portion is positioned at an angle to the slot antenna. The second NFRP antenna portion is positioned at an angle to the slot antenna. The third NFRP antenna portion is positioned at an angle to the second NFRP antenna portion.

In Example 2B, the subject matter of Example 1B can optionally include that the first slot antenna portion and the second slot antenna portion are positioned relative to each other to form a port region to connect to a radio frequency (RF) connector having a first RF cable and a second RF cable. The first slot antenna portion is electrically conductively coupled to the first RF cable and the second slot antenna portion is electrically conductively coupled to the second RF cable.

In Example 3B, the subject matter of Example 2B can optionally include that the first slot antenna portion and the second slot antenna portion are positioned relative to each other to form a substantially rectangular slot portion in the port region.

In Example 4B, the subject matter of any one of Examples 2B or 3B can optionally include that the first slot antenna portion and the second slot antenna portion are positioned relative to each other to form a tapered slot portion extending from the port region.

In Example 5B, the subject matter of Example 4B can optionally include that the first slot antenna portion and the second slot antenna portion are positioned relative to each other to form a tapered triangular slot portion extending from the port region.

In Example 6B, the subject matter of any one of Examples 1B to 6B can optionally include that the multi-feed antenna structure further includes an NFRP antenna feed portion configured to receive Near-Field radio signals.

In Example 7B, the subject matter of Example 6B can optionally include that the NFRP antenna feed portion includes an opening to feed the NFRP antenna on the same plane with the slot antenna. The opening is capacitively coupled with the first slot antenna portion, the second slot antenna portion and the first NFRP antenna portion.

In Example 8B, the subject matter of Example 7B can optionally include that the opening includes or is a rectangular opening.

In Example 9B, the subject matter of any one of Examples 1B to 8B can optionally include that the multi-feed antenna structure further includes an antenna ground structure.

In Example 10B, the subject matter of any one of Examples 1B to 9B can optionally include that the slot antenna and the NFRP antenna are configured to have orthogonal polarization to each other.

In Example 11B, the subject matter of any one of Examples 1B to 10B can optionally include that the multi-feed antenna structure further includes a cavity. The slot antenna and the NFRP antenna are located in the cavity.

In Example 12B, the subject matter of Example 11B can optionally include that the cavity includes metal.

In Example 13B, the subject matter of any one of Examples 1B to 12B can optionally include that the multi-feed antenna structure further includes a dummy wire electrically conductively coupled to the slot antenna.

In Example 14B, the subject matter of Example 13B can optionally include that the dummy wire includes a dummy cable.

In Example 15B, the subject matter of any one of Examples 2B and 13B or 14B can optionally include that the RF connector and the dummy wire are positioned mirrored to each other.

In Example 16B, the subject matter of Example 15B can optionally include that the first cable and the dummy wire are positioned axis symmetrically to each other with the center of the slot being the symmetry axis.

In Example 17B, the subject matter of any one of Examples 1B to 16B can optionally include that the first NFRP antenna portion is positioned perpendicular to the slot antenna.

In Example 18B, the subject matter of any one of Examples 1B to 17B can optionally include that the second NFRP antenna portion is positioned perpendicular to the slot antenna.

In Example 19B, the subject matter of any one of Examples 1B to 18B can optionally include that the third NFRP antenna portion is positioned perpendicular to the second NFRP antenna portion.

In Example 20B, the subject matter of any one of Examples 9B to 19B can optionally include that the third NFRP antenna portion is capacitively coupled to the slot antenna portion and the antenna ground structure.

In Example 21B, the subject matter of any one of Examples 1B to 20B can optionally include that the third NFRP antenna portion extends from the second NFRP antenna portion towards the first NFRP antenna portion.

In Example 22B, the subject matter of any one of Examples 1B to 21B can optionally include that the third NFRP antenna portion extends parallel with the first slot antenna portion and the second slot antenna portion.

In Example 23B, the subject matter of any one of Examples 1B to 22B can optionally include that the multi-feed antenna structure is configured to provide an isolation of at least 35 dB between the slot antenna and the NFRP antenna.

In Example 24B, the subject matter of Example 23B can optionally include that the multi-feed antenna structure is configured to provide an isolation of at least 40 dB between the slot antenna and the NFRP antenna.

In Example 25B, the subject matter of any one of Examples 23B or 24B can optionally include that the multi-feed antenna structure is configured to provide an isolation of at least 35 dB between the slot antenna and the NFRP antenna over a frequency band from about 5 GHz to about 7 GHz.

Example 26B is a radio communication device. The radio communication device may include a multi-feed antenna structure of any one of Examples 1B to 25B; and a baseband processor configured to provide signals to the multi-feed antenna structure or to receive signals from the multi-feed antenna structure.

Example 1C is a multi-feed antenna structure. The multi-feed antenna structure may include a grounding structure; a first antenna port; a first radiating structure coupled to the first antenna port and mounted on the grounding structure; a second antenna port; a second radiating structure coupled to the second antenna port and mounted on the grounding structure; an electrically conductive isolation portion positioned between the first radiating structure and the second radiating structure, wherein the electrically conductive isolation portion is coupled to the grounding structure via a filter structure; and a cutout in the grounding structure, wherein the cutout extends from or between the first radiating structure and the second radiating structure and below the electrically conductive isolation portion.

In Example 2C, the subject matter of Example 1C can optionally include that the electrically conductive isolation portion is mounted on a mounting portion of the grounding structure. The mounting portion extends over the cutout.

In Example 3C, the subject matter of any one of Examples 1C or 2C can optionally include that the filter structure includes a resistor-inductor-filter structure.

In Example 4C, the subject matter of any one of Examples 1C to 3C can optionally include that the first radiating structure is configured to resonate in a frequency range from about 2.4 GHz to about 2.5 GHz and from about 5.1 GHz and about 7.125 GHz. However, it is to be noted that the Examples may be used between any two or more antennas to achieve a required or desired isolation by adjusting the grounding structure (e.g. a ground slot) and metal isolation circuit with one or more filter arrangements.

In Example 5C, the subject matter of any one of Examples 1C to 4C can optionally include that the second radiating structure is configured to resonate in a frequency range from about 5.1 GHz and about 7.125 GHz. By way of example, for a first multi band antenna (as an example of the first radiating structure) and a second antenna (as an example of the second radiating structure), an isolation circuit can be extended between multiple and multi-band antennas to achieve better isoattenuation among them. As an example shown here for 2.4-2.5 GHz and 5-7.125 GHz, etc. It is to be noted that the isolation circuit may be used between any two antennas.

In Example 6C, the subject matter of any one of Examples 1C to 5C can optionally include that the first antenna port and the second antenna port are positioned at a distance of at least about 25 mm from each other. However, it is to be noted that the antenna ports may be positioned as close as possible based on requirements and isolation that can be achieved.

In Example 7C, the subject matter of any one of Examples 1C to 6C can optionally include that the cutout has a first cutout portion and a second cutout portion. The first cutout portion extends from the first radiating structure to the mounting portion of the grounding structure. The second cutout portion extends from the mounting portion of the grounding structure to the second radiating structure. It is to be noted that in general any number of cutout portions may be provided, e.g. three, four, five, six, seven, eight or even more.

In Example 8C, the subject matter of Example 7C can optionally include that the first cutout portion has an extension from the first radiating structure to the mounting portion of the grounding structure in the range from about 8 mm to about 9 mm. The extension of the first cutout portion may be subject of optimization and it may depend on how much isolation is required or desired in a specific design.

In Example 9C, the subject matter of any one of Examples 7C or 8C can optionally include that the second cutout portion has an extension from the mounting portion of the grounding structure to the first radiating structure in the range from about 3 mm to about 5 mm. The extension of the second cutout portion may be subject of optimization and it may depend on how much isolation is required or desired in a specific design.

In Example 10C, the subject matter of any one of Examples 7C to 9C can optionally include that the first cutout portion has a depth in the range from about 4 mm to about 6 mm. The depth of the first cutout portion may be subject of optimization and it may depend on how much isolation is required or desired in a specific design.

In Example 11C, the subject matter of any one of Examples 7C to 10C can optionally include that the second cutout portion has a depth in the range from about 2 mm to about 3 mm. The depth of the second cutout portion may be subject of optimization and it may depend on how much isolation is required or desired in a specific design.

In Example 12C, the subject matter of any one of Examples 1C to 11C can optionally include that the multi-feed antenna structure is configured to provide at least 20 dB isolation between the first radiating structure and the second radiating structure.

Example 13C is a radio communication device. The radio communication device may include a multi-feed antenna structure of any one of Examples 1C to 12C; and a baseband processor configured to provide signals to the multi-feed antenna structure or to receive signals from the multi-feed antenna structure.

Example 1D is a multi-feed antenna structure. The multi-feed antenna structure may include a grounding structure; a first antenna port; a first radiating structure coupled to the first antenna port and mounted on the grounding structure; a second antenna port; a second radiating structure coupled to the second antenna port and mounted on the grounding structure; a plurality of electrically conductive isolation portions positioned between the first radiating structure and the second radiating structure. The plurality of electrically conductive isolation portions comprises a first electrically conductive isolation portion, a second electrically conductive isolation portion, and a third electrically conductive isolation portion. The first electrically conductive isolation portion is positioned between the first radiating structure and the second electrically conductive isolation portion. The third electrically conductive isolation portion is positioned between the second radiating structure and the second electrically conductive isolation portion. The first electrically conductive isolation portion is coupled to the grounding structure via a first filter structure and the third electrically conductive isolation portion is coupled to the grounding structure via a second filter structure (which may be different from the first filter structure). The second electrically conductive isolation portion is directly coupled to the ground structure. In other words, there is no filter structure connected between the second electrically conductive isolation portion and the grounding structure.

In Example 2D, the subject matter of Example 1D can optionally include that the first filter structure includes a resistor-inductor-filter structure.

In Example 3D, the subject matter of any one of Examples 1D or 2D can optionally include that the second filter structure includes a resistor-inductor-filter structure.

In Example 4D, the subject matter of any one of Examples 1D to 3D can optionally include that the first radiating structure is configured to resonate in a frequency range from about 2.4 GHz to about 2.5 GHz and from about 5.1 GHz and about 7.125 GHz. However, it is to be noted that the Examples may be used between any two or more antennas to achieve a required or desired isolation by adjusting the grounding structure (e.g. a ground slot) and metal isolation circuit with one or more filter arrangements.

In Example 5D, the subject matter of any one of Examples 1D to 4D can optionally include that the second radiating structure is configured to resonate in a frequency range from about 5.1 GHz and about 7.125 GHZ. By way of example, for a first multi band antenna (as an example of the first radiating structure) and a second antenna (as an example of the second radiating structure), an isolation circuit can be extended between multiple and multi-band antennas to achieve better isoattenuation among them. As an example shown here for 2.4 to 2.5 GHz and 5 to 7.125 GHZ, etc. It is to be noted that the isolation circuit may be used between any two antennas.

In Example 6D, the subject matter of any one of Examples 1D to 5D can optionally include that the first antenna port and the second antenna port are positioned at a distance of at least about 25 mm from each other. However, it is to be noted that the antenna ports may be positioned as close as possible based on requirements and isolation that can be achieved.

In Example 7D, the subject matter of any one of Examples 1D to 6D can optionally include that the multi-feed antenna structure is configured to provide at least 20 dB isolation between the first radiating structure and the second radiating structure.

Example 8D is a radio communication device. The radio communication device may include a multi-feed antenna structure of any one of Examples 1D to 7D; and a baseband processor configured to provide signals to the multi-feed antenna structure or to receive signals from the multi-feed antenna structure.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A multi-feed antenna structure, comprising:
a first antenna port;
a first radiating structure coupled to the first antenna port;
a second antenna port;
a second radiating structure coupled to the second antenna port;
an electromagnetic metamaterial structure located between the first radiating structure and the second radiating structure.

2. The multi-feed antenna structure of claim 1, further comprising:
a carrier;
wherein the first antenna port, the first radiating structure, the second antenna port, the second radiating structure, and the electromagnetic metamaterial structure are located on the carrier.

3. The multi-feed antenna structure of claim 1, wherein the first radiating structure, the second radiating structure, and the electromagnetic metamaterial structure are printed on the carrier.

4. The multi-feed antenna structure of claim 1,
wherein the metamaterial structure comprises electrically conductive material.

5. The multi-feed antenna structure of claim 4,
wherein the electromagnetic metamaterial structure comprises metal.

6. The multi-feed antenna structure of claim 1,
wherein the electromagnetic metamaterial structure comprises a periodic structure.

7. The multi-feed antenna structure of claim 6,
wherein the periodic structure comprises electrically conductive elements arranged in a periodic distance from each other in at least one direction.

8. The multi-feed antenna structure of claim 7,
wherein the periodic structure comprises a grid structure or an elliptical structure.

9. The multi-feed antenna structure of claim 8,
wherein the electromagnetic metamaterial structure comprises a frame surrounding the periodic structure.

10. The multi-feed antenna structure of claim 1,
wherein the electromagnetic metamaterial structure is configured as an electromagnetic filter.

11. The multi-feed antenna structure of claim 10,
wherein the electromagnetic metamaterial structure is configured as an electromagnetic stopband filter.

12. The multi-feed antenna structure of claim 1,
configured to simultaneously transmit and/or receive radio signals.

13. The multi-feed antenna structure of claim 1,
configured as a Dual-Radio Connectivity antenna structure.

14. The multi-feed antenna structure of claim 1,
wherein the electromagnetic metamaterial structure is configured to provide at least 20 dB isolation between the first radiating structure and the second radiating structure.

15. The multi-feed antenna structure of claim 1, further comprising:
a third antenna port;
a third radiating structure coupled to the third antenna port.

16. A radio communication device, comprising:
the multi-feed antenna structure of claim 1; and
a baseband processor configured to provide signals to the multi-feed antenna structure or to receive signals from the multi-feed antenna structure.

17. A multi-feed antenna structure, comprising:
a slot antenna, comprising a first slot antenna portion, a second slot antenna portion and a slot separating the first slot antenna portion and a second slot antenna portion from each other;
a Near-Field Resonant Parasitic (NFRP) antenna comprising a first NFRP antenna portion, a second NFRP antenna portion and a third NFRP antenna portion electrically conductively coupled to the second NFRP antenna portion;
wherein the first NFRP antenna portion is positioned at an angle to the slot antenna; the second NFRP antenna portion is positioned at an angle to the slot antenna; and the third NFRP antenna portion is positioned at an angle to the second NFRP antenna portion.

18. The multi-feed antenna structure of claim 17, wherein the first slot antenna portion and the second slot antenna portion are positioned relative to each other to form a port region to connect to a radio frequency (RF) connector having a first RF cable and a second RF cable; the first slot antenna portion is electrically conductively coupled to the first RF cable; and the second slot antenna portion is electrically conductively coupled to the second RF cable.

19. The multi-feed antenna structure of claim 18, wherein the first slot antenna portion and the second slot antenna portion are positioned relative to each other to form a substantially rectangular slot portion in the port region.

20. The multi-feed antenna structure of claim 19, wherein the first slot antenna portion and the second slot antenna portion are positioned relative to each other to form a tapered slot portion extending from the port region.
